(19) United States
(12) Patent Application Publication
(10) Pub. No.: US 2019/0198954 A1
(43) Pub. Date: Jun. 27, 2019

(54) DEVICE TEMPERATURE REGULATOR

(71) Applicant: DENSO CORPORATION, Kariya-city (JP)

(72) Inventors: Koji MIURA, Kariya-city (JP); Yasumitsu OMI, Kariya-city (JP); Masayuki TAKEUCHI, Kariya-city (JP); Takeshi YOSHINORI, Kariya-city (JP); Takashi YAMANAKA, Kariya-city (JP); Yoshiki KATO, Kariya-city (JP)

(21) Appl. No.: 16/293,844

(22) Filed: Mar. 6, 2019

Related U.S. Application Data
(63) Continuation of application No. PCT/JP2017/028063, filed on Aug. 2, 2017.

(30) Foreign Application Priority Data
Sep. 9, 2016 (JP) 2016-176794

(51) Int. Cl. H01M 10/6569; B60K 11/02; F28D 15/06; H01M 10/613; H01M 10/615; H01M 10/625; H01M 10/6556; H01M 10/6571; H01M 10/663

(52) U.S. Cl. CPC H01M 10/6569; B60K 11/02; F28D 15/06; H01M 10/613; H01M 2220/20; H01M 10/625; H01M 10/6556; H01M 10/6571; H01M 10/663; H01M 10/615

(57) ABSTRACT

A device temperature regulator is provided with a device heat exchanger that functions as an evaporator at the time of cooling a temperature regulation target device and that functions as a heat radiator at the time of warming up the temperature regulation target device, and a condenser that condenses a gaseous working fluid. The device temperature regulator is provided with a heater that heats the working fluid collecting in a device fluid circuit, and a liquid amount regulator that regulates a liquid amount of the working fluid collecting in the device heat exchanger. The device heat exchanger includes a heat exchange portion that exchanges heat with the temperature regulation target device. The liquid amount regulator regulates the liquid amount of the liquid working fluid collecting in the device heat exchanger.

### CROSS REFERENCE TO RELATED APPLICATIONS

The present application is a continuation application of International Patent Application No. PCT/JP2017/028063 filed on Aug. 2, 2017, which designated the United States and claims the benefit of priority from Japanese Patent Application No. 2016-176794 filed on Sep. 9, 2016. The entire disclosures of all of the above applications are incorporated herein by reference.

### TECHNICAL FIELD

The present disclosure relates to a device temperature regulator that can regulate a temperature of at least one temperature regulation target device.

### BACKGROUND

In a battery temperature regulator, heat is absorbed from a battery in an evaporator as a battery temperature regulation part to thereby evaporate a refrigerant in the battery temperature regulation part, and the evaporated refrigerant is condensed in a condenser, so as to cool a battery.

### SUMMARY

The present disclosure is for a device temperature regulator that can regulate a temperature of at least one temperature regulation target device.

According to at least one embodiment of the present disclosure, a device temperature regulator includes: a device heat exchanger configured to function as an evaporator in which a liquid working fluid is evaporated by absorbing heat from the temperature regulation target device at the time of cooling the temperature regulation target device, and to function as a heat radiator in which a gaseous working fluid is condensed to radiate heat to the temperature regulation target device at the time of warming up the temperature regulation target device; a condenser that is disposed above the device heat exchanger to condense a gaseous working fluid evaporated in the device heat exchanger at the time of cooling the temperature regulation target device; a gas passage part configured to guide the gaseous working fluid evaporated in the device heat exchanger to the condenser; a liquid passage part configured to guide the liquid working fluid condensed in the condenser to the device heat exchanger; at least one heater configured to heat the working fluid in a device fluid circuit that is configured to include the device heat exchanger, the condenser, the gas passage part, and the liquid passage part; and a liquid amount regulator configured to regulate a liquid amount of the working fluid collecting in the device heat exchanger.

The device heat exchanger may be configured to include a heat exchange portion disposed opposite to the temperature regulation target device to exchange heat with the temperature regulation target device. The liquid amount regulator may be configured to regulate the liquid amount of the liquid working fluid collecting in the device heat exchanger such that an occupancy rate of the gaseous working fluid inside the heat exchange portion becomes larger at the time of warming up the temperature regulation target device as compared with that at the time of cooling the temperature regulation target device.

### BRIEF DESCRIPTION OF THE DRAWINGS

FIG. 1 is a schematic general configuration diagram of a device temperature regulator of a first embodiment.

FIG. 2 is a graph to show input/output characteristics of a battery pack.

FIG. 3 is a schematic diagram of the device temperature regulator of the first embodiment.

FIG. 4 is a schematic diagram to show an interior of a device heat exchanger of the device temperature regulator of the first embodiment.

FIG. 5 is a flow chart to show a flow of control processing performed by a control device of the device temperature regulator of the first embodiment.

FIG. 6 is a diagram to illustrate an operation at the time of a cooling mode of the device temperature regulator of the first embodiment.

FIG. 7 is a diagram to illustrate an operation at the time of a warming-up mode of the device temperature regulator of the first embodiment.

FIG. 8 is a diagram to illustrate a detailed operation at the time of the warming-up mode of the device temperature regulator of the first embodiment.

FIG. 9 is a schematic diagram of a device temperature regulator of a first modification of the first embodiment.

FIG. 10 is a schematic diagram of a device temperature regulator of a second modification of the first embodiment.

FIG. 11 is a schematic diagram of a device temperature regulator of a third modification of the first embodiment.

FIG. 12 is a schematic diagram of a device temperature regulator of a fourth modification of the first embodiment.

FIG. 13 is a schematic diagram of a device temperature regulator of a fifth modification of the first embodiment.

FIG. 14 is a schematic diagram of a device temperature regulator of a sixth modification of the first embodiment.

FIG. 15 is a schematic diagram to show a main portion of a device temperature regulator of a seventh modification of the first embodiment.

FIG. 16 is a schematic diagram to show a main portion of a device temperature regulator of an eighth modification of the first embodiment.

FIG. 17 is a flow chart to show a flow of control processing performed by a control device of a device temperature regulator of a ninth modification of the first embodiment.

FIG. 18 is a schematic general configuration diagram of a device temperature regulator of a second embodiment.

FIG. 19 is a flow chart to show a flow of control processing performed by a control device of the device temperature regulator of the second embodiment.

FIG. 20 is a schematic general configuration diagram of a device temperature regulator of a third embodiment.

FIG. 21 is a schematic diagram of the device temperature regulator of the third embodiment.

FIG. 22 is a flow chart to show a flow of control processing performed by a control device of the device temperature regulator of the third embodiment.

FIG. 23 is a schematic diagram of a device temperature regulator of a modification of the third embodiment.

FIG. 24 is a schematic general configuration diagram of a device temperature regulator of a fourth embodiment.

FIG. 25 is a schematic diagram of the device temperature regulator of the fourth embodiment.

FIG. 26 is a flow chart to show a flow of control processing performed by a control device of the device temperature regulator of the fourth embodiment.

FIG. 27 is a schematic diagram of a device temperature regulator of a fifth embodiment.

FIG. 28 is a cross-sectional view taken on a line XXVIII-XXVIII in FIG. 27.

FIG. 29 is a diagram to illustrate a liquid surface position of a device heat exchanger at the time of a warming-up mode of the device temperature regulator of the fifth embodiment.

FIG. 30 is a diagram to illustrate an operation at the time of a cooling mode of the device temperature regulator of the fifth embodiment.

FIG. 31 is a diagram to illustrate an operation at the time of the warming-up mode of the device temperature regulator of the fifth embodiment.

FIG. 32 is a diagram to illustrate a liquid surface change in the device heat exchanger at the time of the cooling mode and at the time of the warming-up mode of the device temperature regulator of the fifth embodiment.

FIG. 33 is a schematic diagram of a device temperature regulator of a sixth embodiment.

FIG. 34 is a diagram to illustrate a liquid surface position of a device heat exchanger at the time of a warming-up mode of the device temperature regulator of the sixth embodiment.

FIG. 35 is a diagram to illustrate an operation at the time of a cooling mode of the device temperature regulator of the sixth embodiment.

FIG. 36 is a diagram to illustrate an operation at the time of the warming-up mode of the device temperature regulator of the sixth embodiment.

### DESCRIPTION OF EMBODIMENTS

A battery temperature regulator may be configured such that a liquid refrigerant in a battery temperature regulation part is evaporated by a heating member arranged in the battery temperature regulation part and the evaporated refrigerant is condensed in the battery temperature regulation part, so as to heat a battery.

For example, the battery temperature regulation part is opposed to a side of the battery. In other words, a portion on an upper side of the battery is opposed to a position in which a gas refrigerant collects in the battery temperature regulation part and that a portion on a lower side of the battery is opposed to a position in which the liquid refrigerant collects in the battery temperature regulation part.

In a portion in which the liquid refrigerant collects in the battery temperature regulation part, the refrigerant is not condensed at the time of warming-up the battery as a temperature regulation target device. In other words, in the battery as the temperature regulation target device, a portion close to the portion in which the liquid refrigerant collects in the battery temperature regulation part is not sufficiently heated.

If a wide range of the battery is opposed to a portion in which the liquid refrigerant collects in the battery temperature regulation part, the portion is not sufficiently heated and hence a temperature variation of the battery at the time of warming up the battery will be enlarged. In particular, when the battery is heated, an amount of the liquid refrigerant in the battery temperature regulation part is larger as compared with a case where the battery is cooled, and the temperature variation of the battery is easily enlarged at the time of warming up the battery. An expansion of the temperature variation in the battery will have a large effect on the input/output characteristics of the battery and hence is not preferable. The expansion of the temperature variation at the time of warming up the battery will be caused not only in the battery but also in the other device.

An object of the present disclosure is to provide a device temperature regulator that can suppress a temperature variation of a temperature regulation target device from being enlarged at the time of warming up the temperature regulation target device.

Hereinafter, embodiments of the present disclosure will be described with reference to the drawings. In the respective embodiments below, the same or equivalent parts will be denoted by the same reference characters, and their descriptions will be omitted in some cases. In a case where only a part of constituent elements is described in the embodiment, the constituent elements described in the preceding embodiment can be applied to other parts of the constituent elements. In the following embodiments, the respective embodiments can be combined with each other within a range in which a combination of them does not cause a matter especially, even if the combination of them is not especially clearly described.

### First Embodiment

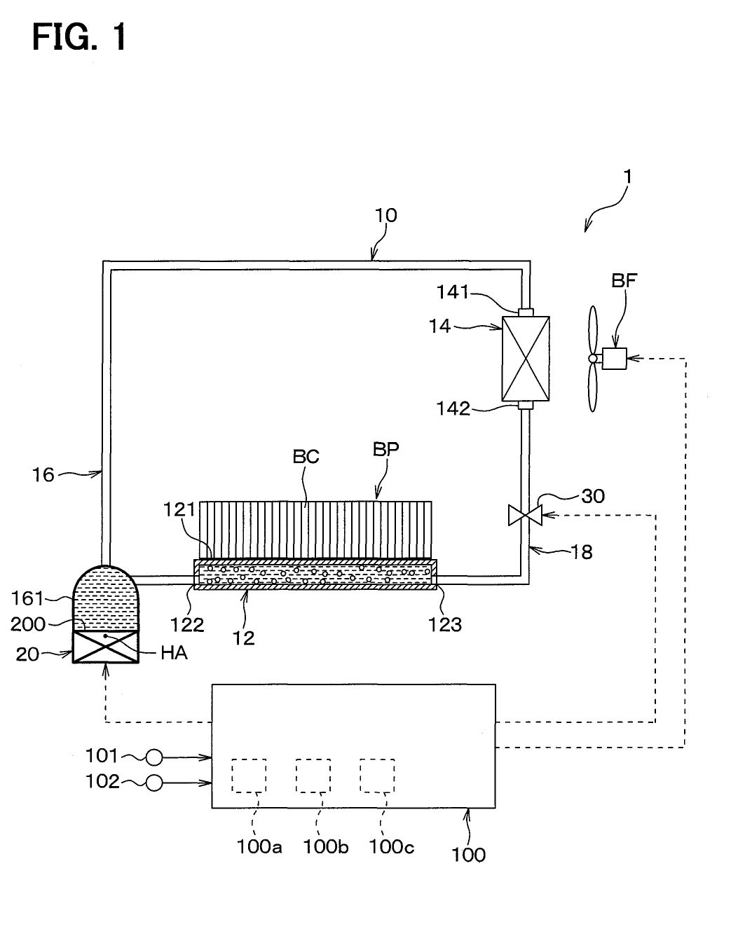

A first embodiment will be described on the basis of FIG. 1 to FIG. 8. The first embodiment will describe an example in which a device temperature regulator 1 of the present disclosure is applied to a device to regulate a battery temperature Tb of a battery pack BP mounted on a vehicle. An electric vehicle, a hybrid vehicle, or the like, which can travel by a travelling electric motor (not shown in the figure) having the battery pack BP as an electric power supply, is assumed as a vehicle mounted with the device temperature regulator 1 shown in FIG. 1.

The battery pack BP is configured of a stack in which a plurality of battery cells BC are stacked, the battery cell BC being formed in a shape of a rectangular parallelepiped. The plurality of battery cells BC to configure the battery pack BP are electrically connected to each other in series. Each battery cell BC to configure the battery pack BP is configured of a secondary battery capable of charging or discharging (for example, a lithium-ion battery, a lead acid battery). A shape of the battery cell BC is not limited to the shape of rectangular parallelepiped but may be another shape such as a cylindrical shape. The battery pack BP may be configured so as to include the battery cells BC electrically connected to each other in parallel.

The battery pack BP is connected to a power converter and a motor generator (not shown in the figure). The power converter is, for example, a device that converts a direct current supplied from the battery pack BP to an alternating current and that supplies (that is, discharges) the converted alternating current to various kinds of electric loads such as the travelling electric motor. Further, the motor generator is a device that, when the vehicle is regenerated, inversely converts a travelling energy of the vehicle to an electric energy and supplies the inversely converted electric energy to the battery pack BP as a regenerative electric power via a power converter or the like.

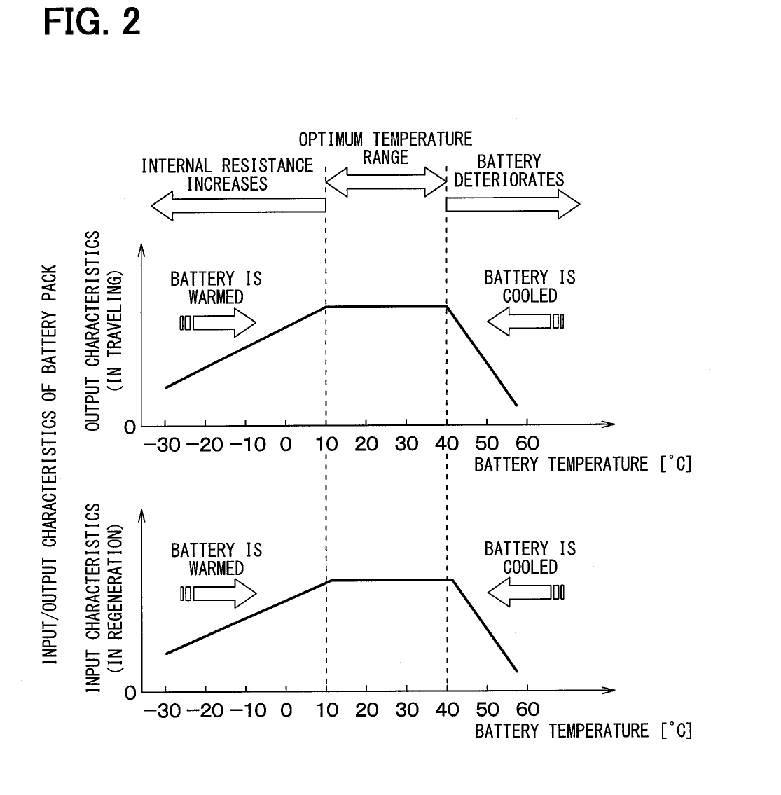

When the battery pack BP supplies the electric power or the like while the vehicle is travelling, the battery pack BP is self-heated and hence is brought into an excessively high temperature in some cases. When the battery pack BP is brought into the excessively high temperature, as shown in FIG. 2, a deterioration of the battery cells BC is advanced and hence an output and an input need to be limited so as to reduce a degree of self-heating. Thus, a cooling means for keeping the temperature of the battery pack BP at a specified temperature or less is required so as to ensure the output and the input of the battery cells BC.

Further, as to the battery pack BP, also while the vehicle is parking in the summer or the like, the battery temperature Tb of the battery pack BP becomes the excessively high temperature in some cases. In other words, an electrical storage device including the battery pack BP is disposed under a floor of the vehicle or on the lower side of a trunk room in many cases, so not only during the time when the vehicle is travelling but also during the time when the vehicle is parking in the summer, the battery temperature Tb of the battery pack BP is gradually increased and the battery pack BP is brought into an excessively high temperature in some cases. When the battery pack BP is left unattended under a high temperature environment, the deterioration of the battery cells BC is advanced to greatly reduce a battery lifetime. Thus, it is preferred that the battery temperature Tb of the battery pack BP is held at a specified temperature or less even while the vehicle is parking or the like.

Still further, the battery pack BP is configured of the plurality of battery cells BC, and if the respective battery cells BC are varied in their temperatures, the respective battery cells BC cause unevenness in a degree of progress of deterioration, which hence will reduce the input and output characteristics of the whole of the battery pack BP. This is because of the following reasons: that is, the battery pack BP includes a series connection body of the battery cells BC, so that the input and output characteristics of the whole of the battery pack BP are determined according to the battery characteristics of the battery cell BC which has the most advanced degree of progress of deterioration among the battery cells BC. For this reason, so as to cause the battery pack BP to exert a preferred performance for a long time, it is important to reduce variations in the temperatures of the respective battery cells BC, that is, to equalize the temperatures of the respective battery cells BC.

A cooling means of an air-cooling type using a blower and a cooling means using a cold heat of a refrigeration cycle of a vapor compression type are generally used as a cooling means for cooling the battery pack BP.

However, the cooling means of an air-cooling type using a blower only sends air or the like in a vehicle compartment to the battery pack BP and hence cannot get a cooling capacity capable of sufficiently cooling the battery pack BP in some cases.

Further, the cooling means using a cold heat of a refrigeration cycle of a vapor compression type has a high cooling capacity of the battery pack BP but needs to drive a compressor or the like, which is high in a power consumption, while the vehicle is parking. This is not preferable because of causing an increase in the power consumption and an increase in noises.

Hence, the device temperature regulator 1 of the present embodiment employs a thermosiphon system which regulates the battery temperature of the battery pack BP not by a forced circulation of a refrigerant by a compressor but by a natural circulation of a working fluid.

The device temperature regulator 1 is a device for regulating a battery temperature Tb of the battery pack BP mounted on the vehicle, the battery pack BP being the temperature regulation target device. As shown in FIG. 1, the device temperature regulator 1 is provided with the device fluid circuit 10 in which the working fluid is circulated and the control device 100. The refrigerant or the like used in the refrigeration cycle of a steam compression type can be employed as the working fluid circulated in the device fluid circuit 10.

In the present embodiment, a refrigerant (for example, R134a, R1234yf) having a property in which a density ratio dr of a saturated liquid density dl to a saturated gas density dg becomes larger as a saturation temperature becomes lower is employed as a working fluid. The density ratio dr of the saturated liquid density dl to the saturated gas density dg is defined by the following mathematical formula F1. Hereinafter, the saturated gas density and the saturated liquid density are simply referred to as a gas density and a liquid density in some cases.

dr=dl/dg (F1)

The device fluid circuit 10 is a heat pipe which transfers heat by the evaporation and the condensation of the working fluid and is configured so as to form a thermosiphon of a loop type in which a flow passage in which a gaseous working fluid flows is separated from a flow passage in which a liquid working fluid flows.

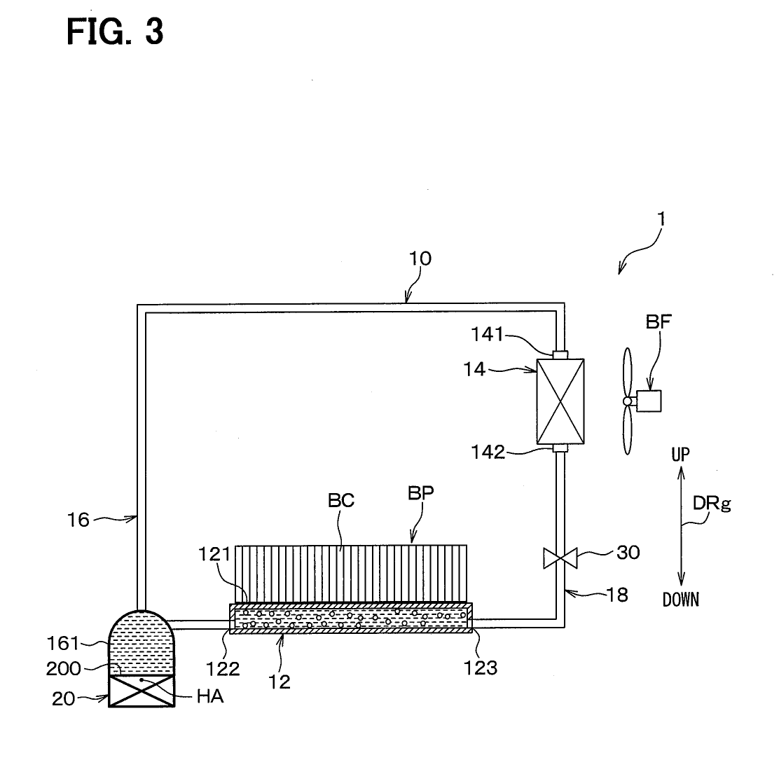

As shown in FIG. 3, the device fluid circuit 10 is configured of a device heat exchanger 12, a condenser 14, a gas passage part 16, and a liquid passage part 18. An arrow DRg shown in FIG. 3 shows a direction in which a vertical line extends, that is, a vertical direction.

The device fluid circuit 10 of the present embodiment has the device heat exchanger 12, the condenser 14, the gas passage part 16, and the liquid passage part 18 connected to each other, thereby being configured as a fluid circuit shaped like a closed ring. The device fluid circuit 10 is filled with a specified amount of working fluid with its interior evacuated.

The device heat exchanger 12 functions as an evaporator that absorbs heat from the battery pack BP to thereby evaporate the liquid working fluid at the time of cooling the battery pack BP of the temperature regulation target device. Further, the device heat exchanger 12 functions as a radiator that condenses the gaseous working fluid therein to thereby transfer heat to the battery pack BP at the time of warming up the battery pack BP. The device heat exchanger 12 is arranged at a position opposed to a bottom surface part side of the battery pack BP. The device heat exchanger 12 has a shape of a thin and flat rectangular parallelepiped.

In the device heat exchanger 12, a device proximity part 121 proximate to a bottom surface part of the battery pack BP configures a heat transfer part to transfer heat between the battery pack BP and the device heat exchanger 12. In the present embodiment, the device proximity part 121 configures a heat exchange portion to exchange heat with the battery pack BP in the device heat exchanger 12. The device proximity part 121 has a size to cover the whole of the bottom surface part of the battery pack BP so as to prevent a temperature variation from being caused in the respective battery cells BC to configure the battery pack BP.

In the device heat exchanger 12, the device proximity part 121 is in contact with the bottom surface portion of the battery pack BP so as to be able to transfer heat between the device heat exchanger 12 and the battery pack BP. In the device heat exchanger 12, the device proximity part 121 may be configured so as to be arranged separately from the bottom surface portion of the battery pack BP if the device proximity part 121 can transfer heat between the device heat exchanger 12 and the battery pack BP.

In a case where a liquid surface of the working fluid in the device heat exchanger 12 is separate from the device proximity part 121 of the device heat exchanger 12, the heat of the battery pack BP is not easily transferred to the liquid working fluid in the device heat exchanger 12. In other words, in the case where the liquid surface of the working fluid in the device heat exchanger 12 is separate from the device proximity part 121 of the device heat exchanger 12, the liquid working fluid collecting in the device heat exchanger 12 is limited from evaporating.

For this reason, the device fluid circuit 10 of the present embodiment is configured such that the liquid surface of the working fluid is in contact with the device proximity part 121 so as to transfer the heat of the battery pack BP to the liquid working fluid collecting in the device heat exchanger 12. In other words, the device fluid circuit 10 of the present embodiment is configured such that an internal space of the device heat exchanger 12 is filled with the liquid working fluid to contain bubbles at the time of cooling the battery pack BP.

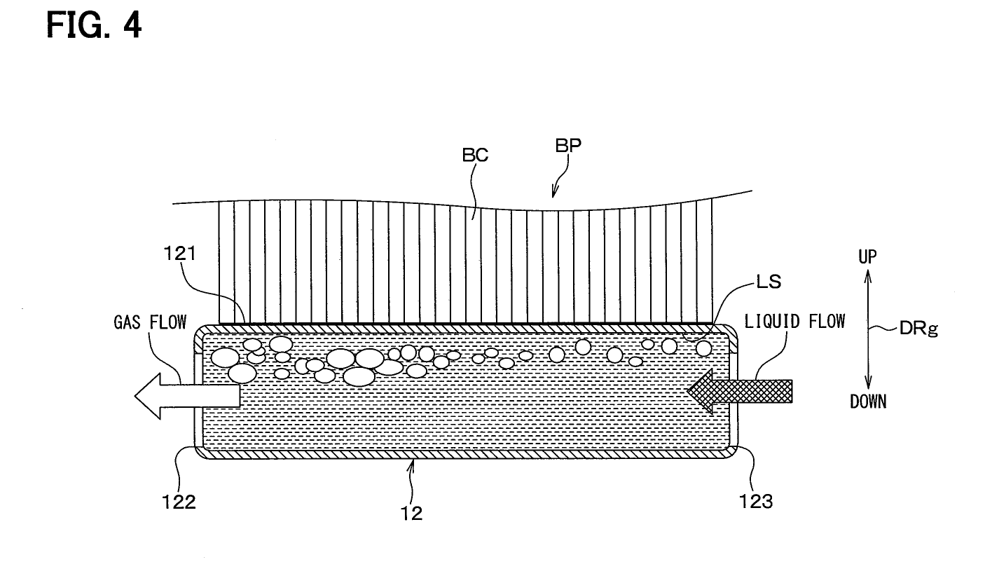

For example, as shown in FIG. 4, in a case where the device heat exchanger 12 is configured of a hollow container, a liquid surface LS of the working fluid collecting in the device heat exchanger 12 is proximate to the device proximity part 121 at the time of cooling the battery pack BP. The device heat exchanger 12 is not limited to the hollow container but may be configured so as to have a plurality of flow passages formed by heat exchange tubes or the like.

Returning to FIG. 3, the device heat exchanger 12 includes a gas outlet part 122, to which an end portion on a lower side of the gas passage part 16 is connected, and a liquid inlet part 123, to which an end portion on a lower side of the liquid passage part 18 is connected. The device heat exchanger 12 of the present embodiment has the gas outlet part 122 and the liquid inlet part 123 provided on its side parts opposite to each other. Further, the device heat exchanger 12 of the present embodiment has the gas outlet part 122 and the liquid inlet part 123 provided at positions of the same level in the vertical direction DRg. In the present embodiment, the gas outlet part 122 configures a gas-side connection part to which the gas passage part 16 is connected in the device heat exchanger 12 and the liquid inlet part 123 configures a liquid-side connection part to which the liquid passage part 18 is connected in the device heat exchanger 12.

The device heat exchanger 12 is configured of metal or alloy having an excellent thermal conductivity such as aluminum and copper. The device heat exchanger 12 can be configured of a material other than the metal but at least the device proximity part 121 to configure a heat transfer part is preferred to be configured of a material having an excellent thermal conductivity.

The condenser 14 is a heat exchanger which condenses the gaseous working fluid evaporated in the device heat exchanger 12. The condenser 14 is configured of an air-cooling type heat exchanger which exchanges heat between the air sent from the blower fan BF and the gaseous working fluid to thereby condense the gaseous working fluid.

The condenser 14 is arranged on an upper side of the device heat exchanger 12 in the vertical direction DRg such that the liquid working fluid condensed in the condenser 14 moves to the device heat exchanger 12 by its own weight.

The condenser 14 includes a gas inlet part 141, to which an end portion on an upper side of the gas passage part 16 is connected, and a liquid outlet part 142, to which an end portion on an upper side of the liquid passage part 18 is connected. In the condenser 14 of the present embodiment, the gas inlet part 141 and the liquid outlet part 142 are provided on portions opposed to the each other in the vertical direction DRg.

Further, in the condenser 14 of the present embodiment, the gas inlet part 141 is arranged on an upper side of the liquid outlet part 142 in the vertical direction DRg. Specifically, in the condenser 14 of the present embodiment, the gas inlet part 141 is provided on an upper end part in the condenser 14 and the liquid outlet part 142 is provided on a lower end part in the condenser 14.

The condenser 14 is configured of metal or alloy having an excellent thermal conductivity such as aluminum and copper. The condenser 14 may be configured so as to include a material other than the metal, but at least a portion to exchange heat with air is preferred to be configured of a material having an excellent thermal conductivity.

The blower fan BF is a device to blow off air inside the vehicle compartment or air outside the vehicle compartment toward the device heat exchanger 12. The blower fan BF functions as a heat radiation amount regulator for regulating a heat radiation amount of the working fluid collecting in the condenser 14. The blower fan BF is configured of an electric fan operated when energized. The blower fan is connected to the control device 100 and has its blowing capacity controlled on the basis of a control signal from the control device 100.

The gas passage part 16 guides the gaseous working fluid evaporated in the device heat exchanger 12 to the condenser 14. The gas passage part 16 has its lower end portion connected to the gas outlet part 122 of the device heat exchanger 12 and has its upper end portion connected to the gas inlet part 141 of the condenser 14. The gas passage part 16 of the present embodiment is configured of a pipe having a flow passage formed therein, the flow passage causing the working fluid to flow in itself. The gas passage part 16 shown in the figure is only one example. The gas passage part 16 can be changed as appropriate in consideration of ease of mounting on the vehicle.

The liquid passage part 18 guides the liquid working fluid condensed in the condenser 14 to the device heat exchanger 12. The liquid passage part 18 has its lower end portion connected to the liquid inlet part 123 of the device heat exchanger 12 and has its upper end portion connected to the liquid outlet part 142 of the condenser 14. The liquid passage part 18 of the present embodiment is configured of a pipe having a flow passage formed therein, the flow passage causing the working fluid to flow in itself.

In the liquid passage part 18 of the present embodiment, a portion on the condenser 14 side is located above a portion on the device heat exchanger 12 side. Further, the liquid passage part 18 of the present embodiment is configured such that a portion on the device heat exchanger 12 side is located at the same level or on an upper side of a portion on a lowermost side of the device heat exchanger 12. The liquid passage part 18 shown in the figure is only one example. The liquid passage part 18 can be changed as appropriate in consideration of an ease of mounting on the vehicle.

In the device temperature regulator 1 of the thermosiphon system, when the temperature of the working fluid collecting on the condenser 14 side is higher than the battery temperature Tb of the battery pack BP, the working fluid in the condenser 14 is hardly condensed and the working fluid in the device heat exchanger 12 is hardly evaporated. In other words, in the device temperature regulator 1, in a case where the temperature of the working fluid on the condenser 14 side in the device fluid circuit 10 is higher than the battery temperature Tb of the battery pack BP, the cooling of the battery pack BP is substantially stopped.

On the other hand, in the device temperature regulator 1 of the thermosiphon system, when the temperature of the working fluid collecting on the condenser 14 side is lower than the battery temperature Tb of the battery pack BP, the working fluid is evaporated in the device heat exchanger 12 and the working fluid is condensed in the condenser 14. In other words, in the device temperature regulator 1, in a case where the temperature of the working fluid on the condenser 14 side in the device fluid circuit 10 is lower than the battery temperature Tb of the battery pack BP, the cooling of the battery pack BP is continued even if the battery temperature Tb of the battery pack BP is within an optimum temperature range.

For this reason, in the device temperature regulator 1 of the thermosiphon system, in a case where the temperature of the working fluid in the condenser 14 is lower than the battery temperature Tb of the battery pack BP, the battery temperature Tb of the battery pack BP is decreased to a level equal to or lower than the optimum temperature range in some cases.

As shown in FIG. 2, when the battery temperature Tb of the battery pack BP is decreased excessively, an internal resistance of the battery pack BP is increased to thereby reduce the input/output characteristics of the battery pack BP. For this reason, it is necessary to take measures so as to prevent the battery temperature Tb of battery pack BP from being excessively decreased.

In contrast to this, the device temperature regulator 1 of the present embodiment is configured so as to be able to increase the battery temperature Tb of the battery pack BP. In other words, the device temperature regulator 1 of the present embodiment, as shown in FIG. 1 and FIG. 3, is provided with a heater 20 that heats the working fluid collecting in the device fluid circuit 10.

The heater 20 is a device that heats the working fluid collecting in the device fluid circuit 10 to thereby evaporate the liquid working fluid. The heater 20 of the present embodiment is arranged at a portion on a lower side of the device proximity part 121 proximate to the battery pack BP in the device heat exchanger 12 of the device fluid circuit 10.

Specifically, the heater 20 is arranged on a lower side of both of the gas outlet part 122 and the liquid inlet part 123 of the device heat exchanger 12. In a case where the gas outlet part 122 and the liquid inlet part 123 of the device heat exchanger 12 are arranged at different positions in the vertical direction DRg, the heating pat 20 is arranged on a lower side of at least one of the gas outlet part 122 and the liquid inlet part 123.

The heater 20 of the present embodiment is arranged on a lower surface part of a tank part 161 provided in the gas passage 16 of the device fluid circuit 10. The tank part 161 stores a portion of the liquid working fluid collecting in the device fluid circuit 10. The tank part 161 is provided on a portion on a lower side in the gas passage 16 of the device fluid circuit 10.

In the present embodiment, a portion opposite to a lower surface part of the tank part 161 in the heater 20 configures a heat radiation portion HA. In the heater 20, the heat radiation portion HA is set so as to be located on a lower side of an upper end of the heat exchange portion to exchange heat with the battery pack BP of the device heat exchanger 12. Specifically, the heat radiation portion HA of the present embodiment is set so as to be located below a lower end of the device proximity part 121.

The heater 20 of the present embodiment is configured of an electric heater that generates heat when it is energized. The heater 20 has its operation controlled by the control device 100 which will be described later. The heater 20 may be configured of not only the electric heater but also, for example, a power converter, a travelling motor, a heat radiator to radiate an exhaust heat of an engine, and the like.

In the device temperature regulator 1, the temperature variation of the battery pack BP is expanded at the time of warming up the battery pack BP in some cases. The present inventors have earnestly studied causes to cause the temperature variation of the battery pack BP at the time of warming up the battery pack BP. As a result, the present inventors have found that the temperature variation of the battery pack BP is caused by the fact that the heat of the working fluid cannot be sufficiently radiated to the battery pack BP side because the liquid working fluid is put into contact with a portion in a wide range in the device proximity part 121 of the device heat exchanger 12.

The present inventors have considered that the temperature variation of the battery pack BP can be limited by regulating a liquid amount of the working fluid in the device heat exchanger 12 at the time of warming up the battery pack BP and have invented a configuration that can regulate the liquid amount of the working fluid in the device heat exchanger 12.

The device temperature regulator 1 of the present embodiment is provided in the liquid passage part 18 with a liquid passage opening/closing valve 30 that opens or closes the liquid passage part 18 so as to regulate the liquid amount of the working fluid in the device heat exchanger 12. The liquid passage opening/closing valve 30 is configured of an electric valve mechanism controlled by the control device 100. Specifically, the liquid passage opening/closing valve 30 of the present embodiment is configured of a normal open type electromagnetic valve that is closed when energized and opened when not energized.

When the liquid passage part 18 is opened by the liquid passage opening/closing valve 30, the device heat exchanger 12 is supplied with the liquid working fluid condensed in the condenser 14. Further, when the liquid passage part 18 is closed by the liquid passage opening/closing valve 30, the supply of the liquid working fluid condensed in the condenser 14 to the device heat exchanger 12 is stopped. For this reason, the liquid passage opening/closing valve 30 functions as a liquid amount regulator that regulates the liquid amount of the liquid working fluid collecting in the device heat exchanger 12.

In the device temperature regulator 1 of the present embodiment, when a condition for eliminating the need for warming up the battery pack BP is satisfied, the liquid passage part 18 is closed such that a part of a portion located on an upper side of the liquid passage opening/closing valve 30 in the device fluid circuit 10 functions as a liquid reservoir.

The condenser 14 of the present embodiment has the gas inlet part 141 arranged on an upper side of the liquid outlet part 142 so as to be able to store the liquid working fluid when the condition for eliminating the need for the temperature regulation of the battery pack BP is satisfied. In other words, the condenser 14 of the present embodiment is arranged on the upper side of the liquid passage opening/closing valve 30 and the gas inlet part 141 is arranged on the upper side of the liquid outlet part 142. For this reason, when the condition for eliminating the need for the temperature regulation of the battery pack BP is satisfied and when the liquid passage part 18 is closed by the liquid passage opening/closing valve 30, the condenser 14 functions as the liquid reservoir LR for storing the liquid working fluid.

In the device temperature regulator 1 of the present embodiment, an internal volume of the liquid reservoir for storing the liquid working fluid is set such that when the liquid passage part 18 is closed by the liquid passage opening/closing valve 30, a liquid surface of the working fluid in the device heat exchanger 12 is located at a specified position.

The liquid surface of the working fluid in the device heat exchanger 12 is varied according to an internal volume of the liquid reservoir. Then, the internal volume of the liquid reservoir is varied according to a position at which the liquid passage opening/closing valve 30 is provided in the liquid passage part 18.

For this reason, the liquid passage opening/closing valve 30 is provided in the liquid passage part 18 such that the liquid surface of the working fluid in the device heat exchanger 12 when the liquid working fluid is stored in the liquid reservoir is located between the device proximity part 121 and the heat radiation portion HA of the heater 20 in the vertical direction DRg. In this way, the device temperature regulator 1 is configured so as to regulate the liquid amount of the working fluid in the device heat exchanger 12 such that the liquid surface of the working fluid in the device heat exchanger 12 is located between the device proximity part 121 and the heat radiation portion HA of the heater 20 in the vertical direction DRg.

The liquid passage opening/closing valve 30 of the present embodiment is configured so as to regulate the liquid amount of the working fluid in the device heat exchanger 12 such that an occupancy rate of the gaseous working fluid inside the device heat exchanger 12 becomes larger at the time of warming up the battery pack BP than at the time of cooling the battery pack BP. Further, the liquid passage opening/closing valve 30 of the present embodiment is configured so as to regulate the liquid amount of the working fluid collecting in the device heat exchanger 12 such that the liquid working fluid collects in at least one portion of a heat receiving portion 200 that receives heat from the heater 20 at the time of warming up the battery pack BP.

Specifically, the liquid passage opening/closing valve 30 is configured so as to regulate the liquid amount of the working fluid in the device heat exchanger 12 such that the liquid surface of the working fluid in the device heat exchanger 12 is located above at least one of the gas outlet part 122 and the liquid inlet part 123 at the time of warming up the battery pack BP.

Subsequently, the control device 100 to configure an electronic control part of the device temperature regulator 1 will be described with reference to FIG. 1. The control device 100 shown in FIG. 1 is configured of a microcomputer including a processor and a storage part (for example, a ROM, a RAM) and its peripheral circuit. The storage part of the control device 100 is configured of a non-transitive substantial storage medium.

The control device 100 performs various calculations and processing on the basis of a control program stored in the storage part. The control device 100 controls operations of various kinds of devices connected to the output side thereof such as the blower fan BF, the heater 20, and the liquid passage opening/closing valve 30.

The control device 100 has a group of various sensors, which includes a battery temperature detection part 101 and a condenser temperature detection part 102, connected to its input side.

The battery temperature detection part 101 is configured of a temperature sensor for detecting the battery temperature Tb of the battery pack BP. The battery temperature detection part 101 may be configured of a plurality of temperature sensors. In this case, the battery temperature detection part 101 may be configured so as to output an average value of the detected values of the plurality of temperature sensors to the control device 100.

The condenser temperature detection part 102 is configured of a temperature sensor for detecting a temperature of the working fluid collecting in the condenser 14. The condenser temperature detection part 102 is not necessarily configured so as to directly detect the temperature of the working fluid collecting in the condenser 14 but may be configured so as to detect a surface temperature of the condenser 14 as the temperature of the working fluid collecting in the condenser 14.

The control device 100 of the present embodiment is a device into which a plurality of control parts, which are configured of hardware and software to control various kinds of devices connected to the output side thereof, are integrated. The control device 100 has a fan control part 100a, a heating control part 100b, and a valve control part 100c integrated thereinto, the fan control part 100a controlling the number of revolutions of the blower fan BF, the heating control part 100b controlling the heater 20, the valve control part 100c controlling an opening/closing state of the liquid passage opening/closing valve 30.

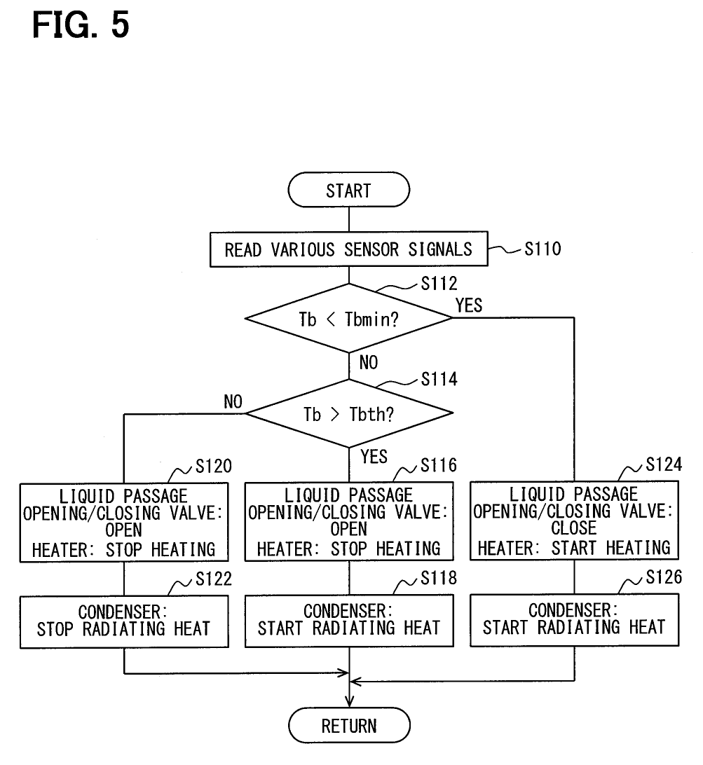

Next, an operation of the device temperature regulator 1 of the present embodiment will be described with reference to a flow chart shown in FIG. 5. Control processing shown in FIG. 5 is performed at a specified cycle by the control device 100 while the vehicle is travelling. Needless to say, the device temperature regulator 1 may be configured such that the control processing shown in FIG. 5 is performed by the control device 100 while the vehicle is parking. Each control step shown in FIG. 5 configures a function realization part which realizes each of various functions performed by the control device 100.

As shown in FIG. 5, the control device 100 reads various sensor signals first in step S110. Specifically, in the processing of step S110, the control device 100 reads the battery temperature Tb of the battery pack BP detected by the battery temperature detection part 101 and the temperature of the working fluid collecting in the condenser 14 detected by the condenser temperature detection part 102.

Subsequently, the control device 100 determines whether or not a condition that requires the battery pack BP to be warmed up is satisfied. In the present embodiment, a condition which is satisfied when the battery temperature Tb of the battery pack BP is lower than a previously-set allowable lower limit temperature Tbmin of the battery pack BP is employed as the condition that requires the battery pack BP to be warmed up. In other words, the control device 100 determines in step S112 whether or not the battery temperature Tb of the battery pack BP is lower than the previously-set allowable lower limit temperature Tbmin of the battery pack BP. The allowable lower limit temperature Tbmin is set to, for example, a temperature (for example, 10° C.) at which the input/output characteristics of the battery pack BP are not easily impaired even if the battery temperature Tb of the battery pack BP is decreased.

In a case where it is determined from a result of determination processing in step S112 that the battery temperature Tb of the battery pack BP is the allowable lower limit temperature Tbmin or more, the control device 100 determines in step S114 whether or not the battery temperature Tb of the battery pack BP is higher than a previously-set cooling necessary temperature Tbth. The cooling necessary temperature Tbth is set a temperature (for example, 40 ° C.) at which the input/output characteristics of the battery pack BP are not easily impaired even if the battery temperature Tb of the battery pack BP is increased.

In a case where it is determined from a result of the determination processing in step S114 that the battery temperature Tb of the battery pack BP is higher than the temperature requiring cooling Tbth, the device temperature regulator 1 proceeds to a cooling mode for cooling the battery pack BP. In other words, in a case where it is determined from the result of the determination processing in step S114 that the battery temperature Tb of the battery pack BP is higher than the temperature requiring cooling Tbth, the control device 100 brings the liquid passage opening/closing valve 30 into an open state in step S116 and stops heating the working fluid by the heater 20. Further, the control device 100 operates the blower fan BF in step S118 to thereby start radiating the heat of the working fluid collecting in the condenser 14.

In the device temperature regulator 1, at the time of the cooling mode, when the battery temperature Tb of the battery pack BP is increased by the self-heating or the like when the vehicle travels, the heat of the battery pack BP is transferred to the device heat exchanger 12. In the device heat exchanger 12, heat is absorbed from the battery pack BP and hence a portion of the liquid working fluid is evaporated. The battery pack BP is cooled by a latent heat of evaporation of the working fluid collecting in the device heat exchanger 12 and hence has its temperature decreased.

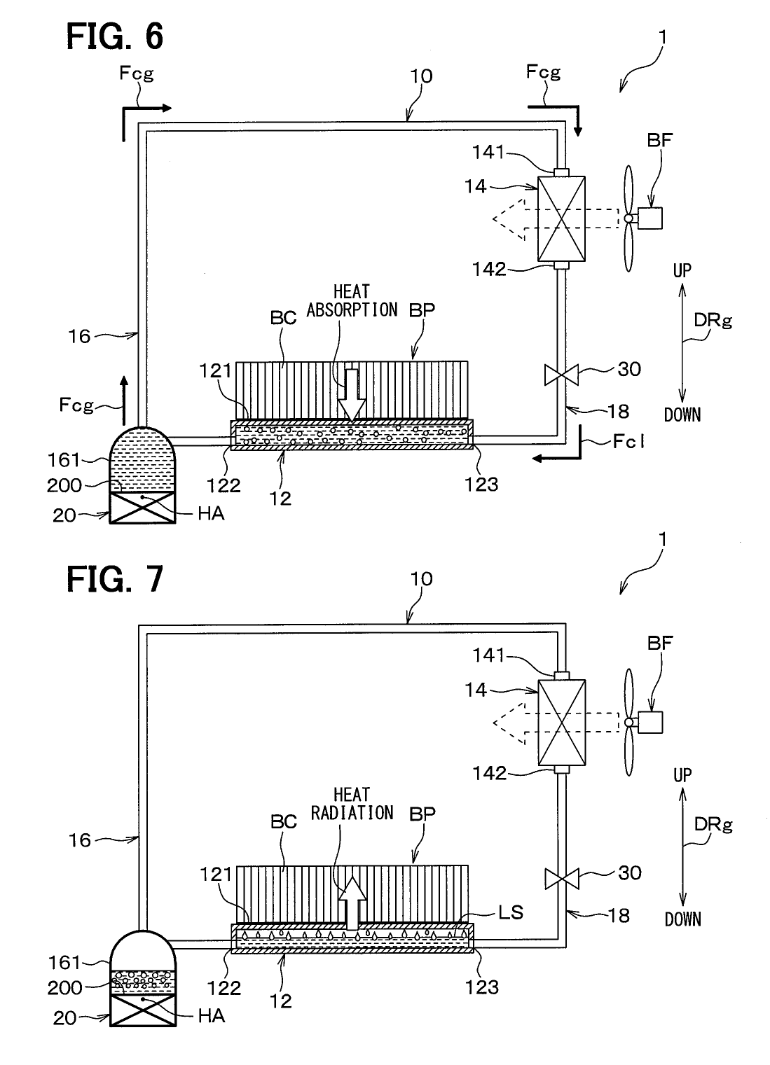

The gaseous working fluid evaporated in the device heat exchanger 12 flows out to the gas passage part 16 from the gas outlet part 122 of the device heat exchanger 12 and moves to the condenser 14 via the gas passage part 16, as shown by an arrow Fcg in FIG. 6.

In the condenser 14, the gaseous working fluid radiates heat to the blown air from the blower fan BF, thereby being condensed. In the condenser 14, the gaseous working fluid is liquefied and hence a specific gravity of the working fluid is increased. In this way, the working fluid liquefied in the condenser 14 is moved down toward the liquid outlet part 142 of the condenser 14 by its own weight.

The liquid working fluid condensed in the condenser 14 flows out to the liquid passage part 18 from the liquid outlet part 142 of the condenser 14 and moves to the device heat exchanger 12 via the liquid passage part 18 as shown by an arrow Fc1 in FIG. 6. Then, in the device heat exchanger 12, a portion of the liquid working fluid flowing into the device heat exchanger 12 from the liquid inlet part 123 via the liquid passage part 18 absorbs heat from the battery pack BP, thereby being evaporated.

In this way, in the device temperature regulator 1, at the time of the cooling mode, the working fluid is circulated between the device heat exchanger 12 and the condenser 14 while changing its phase into a gas state and a liquid state and the heat is transported to the condenser 14 from the device heat exchanger 12, and thereby the battery pack BP is cooled.

At the time of the cooling mode, the liquid passage opening/closing valve 30 is opened. For this reason, at the time of the cooling mode, the internal space of the device heat exchanger 12 is filled with the liquid working fluid containing bubbles. In other words, at the time of the cooling mode, the liquid working fluid is brought into contact with an inside of a portion to exchange heat with the battery pack BP of the device heat exchanger 12. For this reason, at the time of the cooling mode, the battery pack BP can be sufficiently cooled by a heat absorption effect produced by the evaporation of the liquid working fluid collecting in the device heat exchanger 12.

The device temperature regulator 1 is configured such that the working fluid is naturally circulated in the device fluid circuit 10 even if there is not a driving force required for circulating the working fluid by a compressor or the like. For this reason, the device temperature regulator 1 can realize the temperature regulation of the battery pack BP, which depresses both of a power consumption and noises and is efficient as compared with a refrigeration cycle or the like.

Returning to FIG. 5, in a case where it is determined from the result of the determination processing in step S114 that the battery temperature Tb of the battery pack BP is the cooling necessary temperature Tbth or lower, the device temperature regulator 1 stops the heat radiation of the working fluid in the condenser 14.

Specifically, in a case where it is determined from the result of the determination processing in step S114 that the battery temperature Tb of the battery pack BP is the temperature requiring cooling Tbth or lower, the control device 100 brings the liquid passage opening/closing valve 30 into an open state and stops heating the working fluid by the heater 20 in step S120. Further, the control device 100 stops the operation of the blower fan BF to thereby stop the heat radiation of the working fluid collecting in the condenser 14 in step S122.

In the device temperature regulator 1, even if the operation of the blower fan BF is stopped, in a case where the temperature of the working fluid collecting in the condenser 14 is higher than the battery temperature Tb of the battery pack BP, the heat is transferred to the condenser 14 from the device heat exchanger 12, and thereby the battery pack BP is cooled. In other words, in the device temperature regulator 1, if the temperature of the working fluid collecting in the condenser 14 is higher than the battery temperature Tb of the battery pack BP, as is the case with the cooling mode, the battery pack BP is held cooled.

For this reason, in a case where the surrounds of the condenser 14 becomes a low temperature in the winter or the like and hence the temperature of the condenser 14 becomes the low temperature, the battery pack BP is held cooled by the device temperature regulator 1, so that the temperature Tb of the battery pack BP may become lower than the allowable lower limit temperature Tbmin.

In contrast to this, if the battery temperature Tb of the battery pack BP becomes lower than the allowable lower limit temperature Tbmin, the device temperature regulator 1 of the present embodiment proceeds to a warming-up mode so as to prevent the battery pack BP from becoming excessively cooled. In other words, in a case where it is determined from the result of the determination processing in step S112 that the battery temperature Tb of the battery pack BP is lower than the allowable lower limit temperature Tbmin, the control device 100 brings the liquid passage opening/closing valve 30 into a closed state and starts heating the working fluid by the heater 20 in step S124. Further, the control device 100 operates the blower fan BF to thereby start radiating heat of the working fluid collecting in the condenser 14 in step S126.

The device temperature regulator 1 of the present embodiment has the liquid passage part 18 closed by the liquid passage opening/closing valve 30 at the time of the warming-up mode. In other words, in the device temperature regulator 1 of the present embodiment, at the time of the warming-up mode, the supply of the liquid working fluid to the device heat exchanger 12 is stopped. Then, when the working fluid collecting in the condenser 14 starts radiating heat, the liquid working liquid is stored in the condenser 14.

In the device temperature regulator 1, as the liquid working fluid stored in the condenser 14 increases, the liquid working liquid collecting in the device heat exchanger 12 decreases. In this way, in the device temperature regulator 1 of the present embodiment, as shown in FIG. 7, a liquid surface LS of the working fluid in the device heat exchanger 12 goes down to a lower side of the device proximity part 121. In other words, in the device temperature regulator 1 of the present embodiment, the liquid passage opening/closing valve 30 is closed at the time of the warming-up mode, so that the occupancy rate of the gaseous working fluid inside the device proximity part 121 of the device heat exchanger 12 becomes larger as compared with at the time of the cooling mode.

In addition, in the device temperature regulator 1 of the present embodiment, even if the liquid passage opening/closing valve 30 is closed, the liquid working fluid collects in the heat receiving portion 200 to receive heat from the heater 20. For this reason, in the device temperature regulator 1, the working fluid, which is heated by the heater 20 and hence is evaporated, is condensed near the device proximity part 121 of the device heat exchanger 12. In other words, in the device temperature regulator 1, at the time of the warming-up mode, the working fluid is condensed near the device proximity part 121 of the device heat exchanger 12 and the heat of the working fluid at that time is radiated to the battery pack BP, and thereby the battery pack BP is heated.

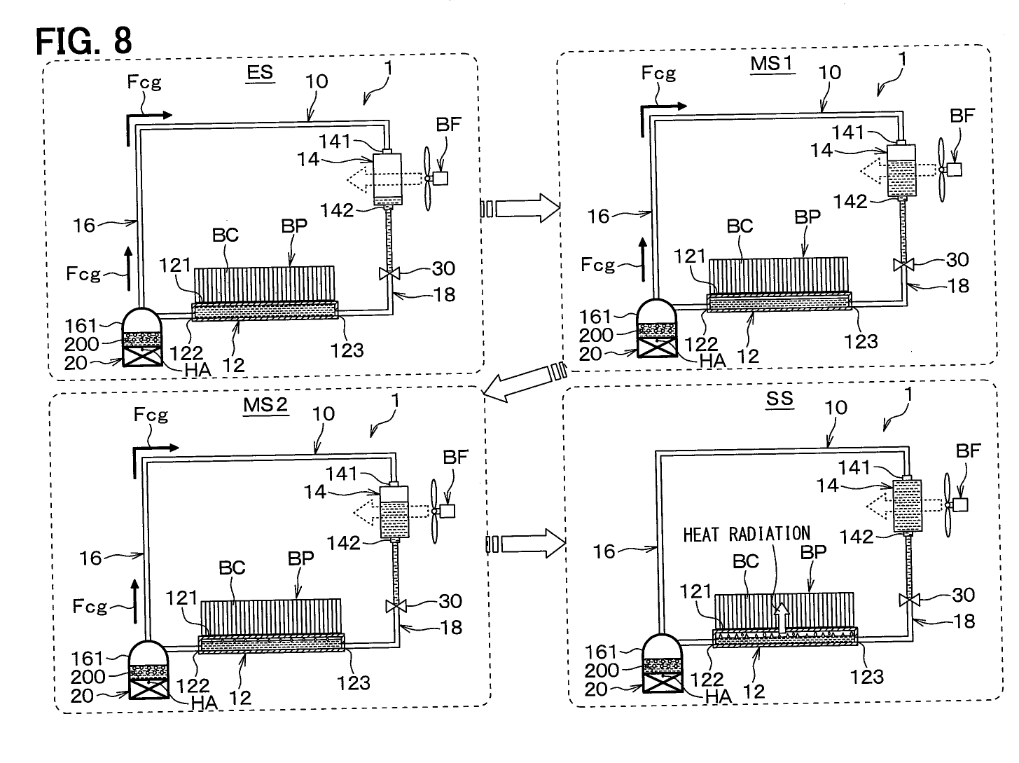

Hereinafter, a detailed operation of the device temperature regulator 1 of the present embodiment will be described with reference to FIG. 8. In FIG. 8, operation states in an initial stage ES, a first middle stage MS1, a second middle stage MS2, and a stable stage SS of warming up the battery pack BP will be shown in an upper left space, an upper right space, a lower left space, and a lower right space, respectively. In the device temperature regulator 1, at the time of the warming-up mode, an operation state proceeds in order of the initial stage ES, the first middle stag MS1, the second middle stage MS2, and the stable stage SS.

As shown in FIG. 8, at the initial stage ES, the liquid working fluid is heated by the heater 20 and the liquid working fluid stored in the tank part 161 is evaporated. At this time, the liquid working fluid collects near the device proximity part 121 of the device heat exchanger 12 and hence the heat of the working fluid is not sufficiently radiated to the battery pack BP side.

In the next first middle stage MS1, the condenser 14 is cooled in a state where the liquid passage part 18 is closed by the liquid passage opening/closing valve 30, so that the liquid working fluid is gradually stored in the condenser 14. In this way, the liquid amount of the working fluid collecting in the device heat exchanger 12 is decreased. Further, in the first middle stage MS1, the liquid working fluid collecting in the device heat exchanger 12 flows into the tank part 161, and thereby the evaporation of the liquid working fluid stored in the tank part 161 is continued.

In the next second middle stage MS2, the liquid working fluid is increased in the condenser 14, and thereby the liquid surface LS of the working fluid colleting in the device heat exchanger 12 is decreased below the device proximity part 121. In this way, the working fluid, which is heated by the heater 20 and is evaporated, is condensed near the device proximity part 121 of the device heat exchanger 12, and thereby the heating of the battery pack BP is started.

In the next stable stage SS, the liquid working fluid is stored in the whole of the condenser 14, so that the condensation of the working fluid in the condenser 14 is stopped. In other words, in the stable stage SS, the condensation of the working fluid is caused only in the device heat exchanger 12.

In this way, in the stable stage SS, almost all of a heat amount from the heater 20 is used for warming up the battery pack BP, which hence improves an energy efficiency at the time of the warming-up mode of the battery pack BP as compared with in the initial stage or the like.

The device temperature regulator 1 of the present embodiment described above is provided with the heater 20, which heats the working fluid collecting in the device fluid circuit 10, and the liquid passage opening/closing valve 30, which functions as the liquid amount regulator for regulating the liquid amount of the working fluid collecting in the device heat exchanger 12. Then, the liquid passage opening/closing valve 30 regulates the liquid amount of the working fluid collecting in the device heat exchanger 12 such that the occupancy rate of the gaseous working fluid inside the portion to exchange heat with the battery pack BP of the device heat exchanger 12 becomes large.

According to this, the device temperature regulator 1 can regulate the liquid amount of the working fluid in the device heat exchanger 12 by the liquid passage opening/closing valve 30 so as to prevent the liquid working fluid from collecting in a portion proximate to the battery pack BP in the device heat exchanger 12 at the time of warming up the battery pack BP.

In this way, at the time of warming up the battery pack BP, the device temperature regulator 1 of the present embodiment can suppress the temperature variation from being expanded at the time of warming up the battery pack BP by regulating the liquid amount of the working fluid in the device heat exchanger 12.

In particular, in the device temperature regulator 1 of the present embodiment, an area in which the gaseous working fluid is in contact with an inside of the portion to exchange heat with the battery pack BP in the device heat exchanger 12 is increased and hence a range in which the working fluid is condensed inside the device proximity part 121 can be expanded.

Thus, according to the device temperature regulator 1 of the present embodiment, at the time of warming up the battery pack BP, the battery pack BP can be heated in a wide range, which can hence suppress the temperature variation from being expanded at the time of warming up the battery pack BP.

Further, at the time of cooling the battery pack BP, an area in which the liquid working fluid is in contact with an inside of the portion to exchange heat with the battery pack BP in the device heat exchanger 12 is increased and hence the refrigerant can be evaporated inside the device proximity part 121. In this way, the battery pack BP can be sufficiently cooled by a heat absorption effect produced by the evaporation of the liquid working fluid.

Further, in the device temperature regulator 1, the heat radiation portion HA of the heater 20 is located below an upper end of the device proximity part 121 of the device heat exchanger 12. Then, the liquid passage opening/closing valve 30 is configured so as to regulate the liquid amount of the working fluid collecting in the device heat exchanger 12 such that the working fluid collects in at least a portion of the heat receiving portion 200 to receive heat from the heater 20 at the time of warming up the battery pack BP. In other words, the device temperature regulator 1 of the present embodiment has the heater 20 arranged at a portion located below the device proximity part 121 of the device heat exchanger 12 and hence is configured so as to heat the liquid working fluid by the heater 20 when the condition that requires the battery pack BP to be warmed up is satisfied.

According to this, at the time of warming up the battery pack BP, the liquid working fluid collecting in the heat receiving portion 200 can be evaporated by the heater 20 and the evaporated gaseous working fluid can be condensed by the device proximity part 121 of the device heat exchanger 12. Thus, the battery pack BP can be efficiently warmed up.

Specially, in the present embodiment, the heat radiation portion HA of the heater 20 is located on a lower side of at least one of the gas outlet part 122 and the liquid inlet part 123 in the device heat exchanger 12 in the vertical direction DRg.

According to this, the liquid working fluid collecting in the device fluid circuit 10 can easily flow to the heater 20 side and the gaseous working fluid, which is heated by the heater 20 and is evaporated, can easily flow to the device heat exchanger 12 side. For this reason, in the device temperature regulator 1 of the present embodiment, at the time of warming up the battery pack BP, the heat of the working fluid can be radiated to the battery pack BP via the device heat exchanger 12.

Further, the device temperature regulator 1 regulates the liquid amount of the working fluid collecting in the device heat exchanger 12 by the liquid passage opening/closing valve 30 such that the liquid surface of the working fluid in the device heat exchanger 12 is located between the heat radiation portion HA of the heater 20 and the device proximity part 121.

According to this, at the time of warming up the battery pack BP, the gaseous working fluid evaporated by the heater 20 can be condensed by the device proximity part 121 proximate to the battery pack BP, so that the heat of the working fluid can be radiated to the battery pack BP via the device heat exchanger 12. At this time, at the time of warming up the battery pack BP, the battery pack BP is close to a portion in which the gaseous working fluid in the device heat exchanger 12 collects and hence the temperature variation of the battery pack BP can be sufficiently inhibited.

Specifically, the device temperature regulator 1 is configured so as to regulate the liquid amount in the device heat exchanger 12 by the liquid passage opening/closing valve 30 such that the liquid surface of the device heat exchanger 12 is located above at least one of the gas outlet part 122 and the liquid inlet part 123 at the time of warming up the battery pack BP.

According to this, at the time of warming up the battery pack BP, the liquid working fluid collecting in the device heat exchanger 12 can easily flow to a side of the heater 20 via at least one of the gas outlet part 122 and the liquid inlet part 123. For this reason, in the device temperature regulator 1, the liquid working fluid can be heated by the heater 20 and hence can be evaporated.

Further, the device temperature regulator 1 of the present embodiment is configured so as to close the liquid passage part 18 by the liquid passage opening/closing valve 30 such that the supply of the liquid working fluid to the device heat exchanger 12 is stopped when the condition that requires the battery pack BP to be warmed up is satisfied.

In this configuration, the supply of the liquid working fluid to the device heat exchanger 12 is stopped and the liquid working fluid is stored on the upper side of the liquid passage opening/closing valve 30, and thereby the liquid amount of the working fluid in the device heat exchanger 12 can be decreased. In this way, at the time of warming up the battery pack BP, the gaseous working fluid evaporated by the heater 20 can be condensed by the device proximity part 121 proximate to the battery pack BP and hence the heat of the working fluid can be radiated to the battery pack BP via the device heat exchanger 12.

Here, the device temperature regulator 1 of the present embodiment is configured so as to operate the blower fan BF such that the heat radiation amount of the working fluid in the condenser 14 is increased when the condition that requires the battery pack BP to be warmed up is satisfied. According to this, at the time of warming up the battery pack BP, the storage amount of liquid working fluid in the condenser 14 is increased and hence the liquid amount of the working fluid in the device heat exchanger 12 can be decreased early.

Further, in the present embodiment, the refrigerant (for example, R134a, R1234yf) having a property in which a density ratio of the liquid density to a gas density becomes larger as the saturation temperature decreases is employed. In a case where the working fluid having this property is used, the liquid amount in the device fluid circuit 10 decreases under an environmental condition in which the battery temperature Tb of the battery pack BP decreases. For this reason, at the time of warming up the battery pack BP, a volume necessary for storing the liquid working fluid in the device fluid circuit 10 can be reduced. In other words, in a case where a working fluid having the property in which the density ratio of the gas density to the liquid density becomes larger as the saturation temperature decreases is used, the device temperature regulator 10 can be reduced in size

### Modifications of the First Embodiment

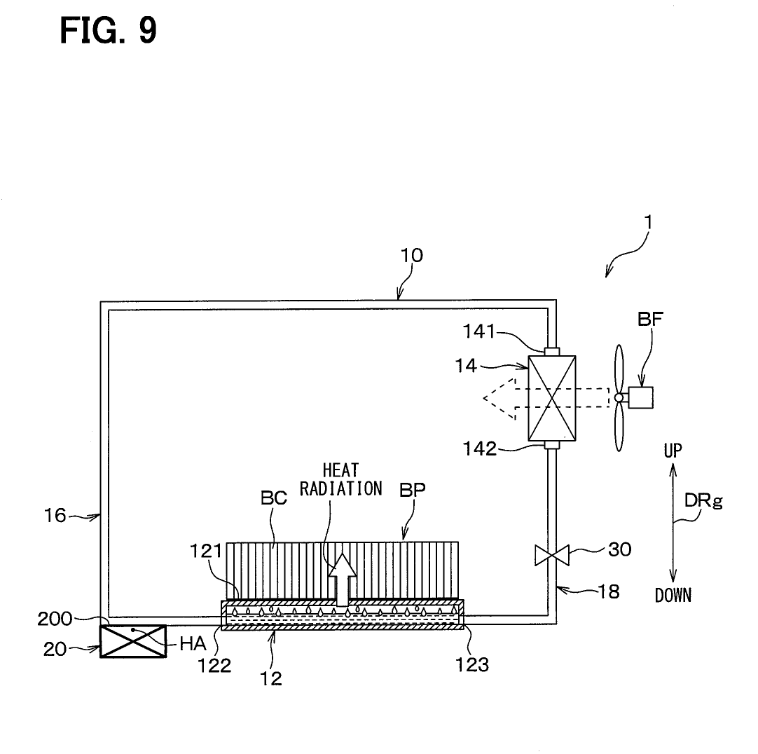

Hereinafter, a first modification to a ninth modification of the device temperature regulator 1 of the first embodiment will be described with reference to FIG. 9 to FIG. 17. Contents described in the present modifications can be applied to the device temperature regulator 1 of the second embodiment to the fourth embodiment, which will be described later, within a range in which a trouble will be not caused in particular.

### First Modification

In the first embodiment described above, the configuration in which the gas passage part 16 of the device fluid circuit 10 is provided with the tank part 161 and in which the heater 20 is arranged on the lower surface part of the tank part 161 has been shown as an example, but the present disclosure is not limited to this.

The device temperature regulator 1 may be configured such that, for example, as shown in FIG. 9, the gas passage part 16 is not provided with the tank part 161. In this case, the heater 20 may be arranged simply at a portion on a lower side of the gas passage part 16. According to this, the gas passage part 16 does not need to be provided with the tank part 161, so that the device temperature regulator 1 can be simplified.

### Second Modification

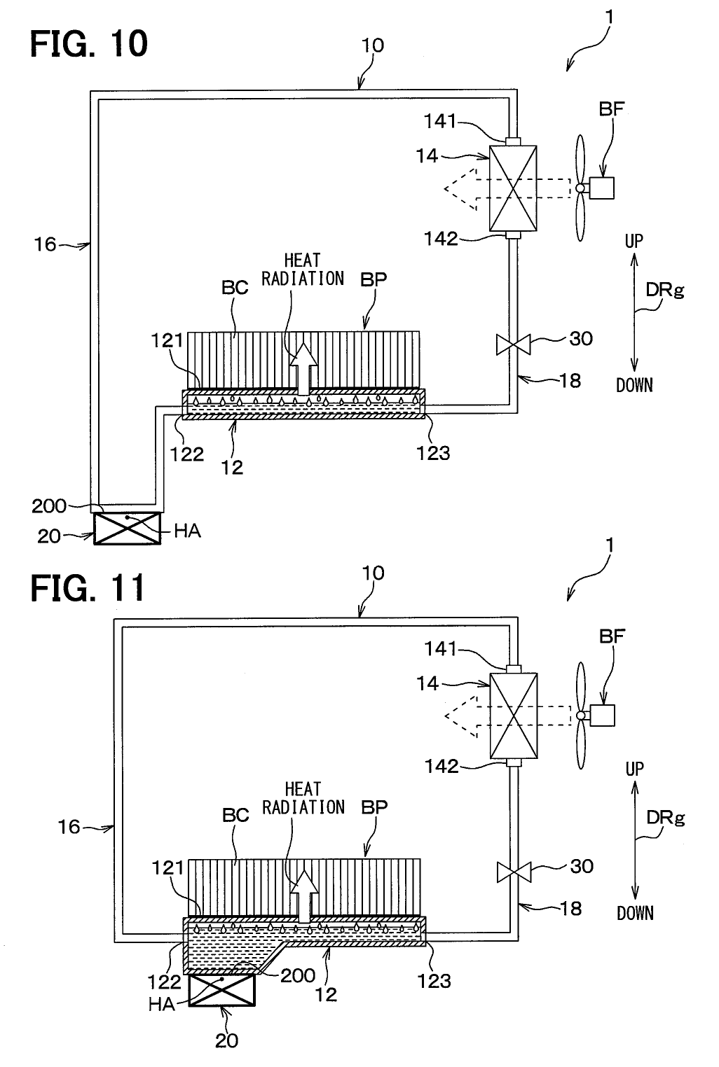

Further, the device temperature regulator 1 may be configured such that, for example, as shown in FIG. 10, a portion on a lower side in the gas passage part 16 is provided with a portion bent in a shape of a letter U and is provided with the heater 20. In this way, if the device temperature regulator 1 is configured such that the portion which is bent in the shape of the letter U and into which the liquid working fluid easily flows is heated by the heater 20, at the time of warming up the battery pack BP, the gaseous working fluid can be supplied to the device heat exchanger 12 sufficiently.

### Third Modification

In the first embodiment described above, a configuration in which the liquid working fluid collecting in the gas passage part 16 in the device fluid circuit 10 is heated by the heater 20 has been shown as an example, but the present disclosure is not limited to this.

The device temperature regulator 1 may be configured such that, for example, as shown in FIG. 11, the heater 20 is arranged on the lower surface part of the device heat exchanger 12 and that the liquid working fluid collecting on the lower surface part side of the device heat exchanger 12 in the device fluid circuit 10 is heated by the heater 20.

### Fourth Modification

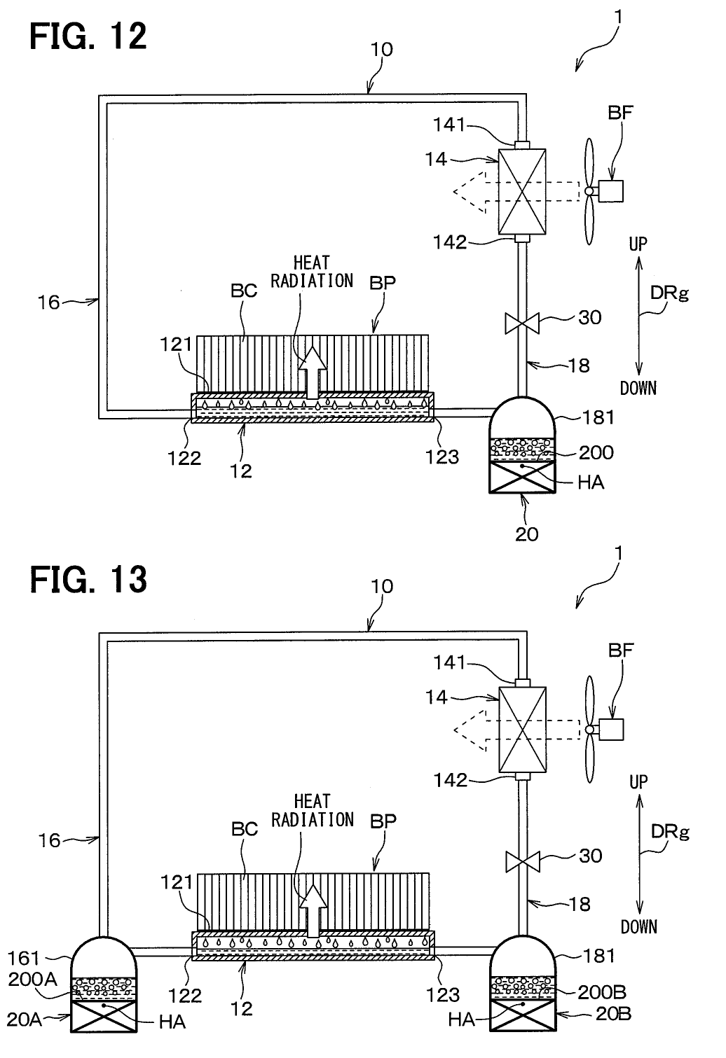

Further, the device temperature regulator 1 may be configured such that, for example, as shown in FIG. 12, the liquid passage part 18 is provided with the tank part 181 and that the heater 20 is arranged on a lower surface part of the tank part 181 and that the liquid working fluid collecting in the liquid passage part 18 is heated by the heater 20. The device temperature regulator 1 may be configured such that the liquid passage part 18 is not provided with the tank part 181. In this case, the heater 20 should be arranged only at a portion on a lower side of the liquid passage part 18.

### Fifth Modification

In the first embodiment described above, the configuration in which the working fluid collecting in the device fluid circuit 10 is heated by a single heater 20 has been shown as an example, but the present disclosure is not limited to this.

The device temperature regulator 1 may be configured such that the working fluid collecting in the device fluid circuit 10 is heated by a plurality of heaters 20. For example, the device temperature regulator 1 may be configured such that, as shown in FIG. 13, both of the gas passage part 16 and the liquid passage part 18 are provided with tank parts 161, 181, respectively, and that heaters 20A, 20B are arranged on the respective lower surface parts of the tank parts 161, 181. Heat receiving portions 200A, 200B in the present modification become the lower surface parts of the respective tank parts 161, 181.

### Sixth Modification

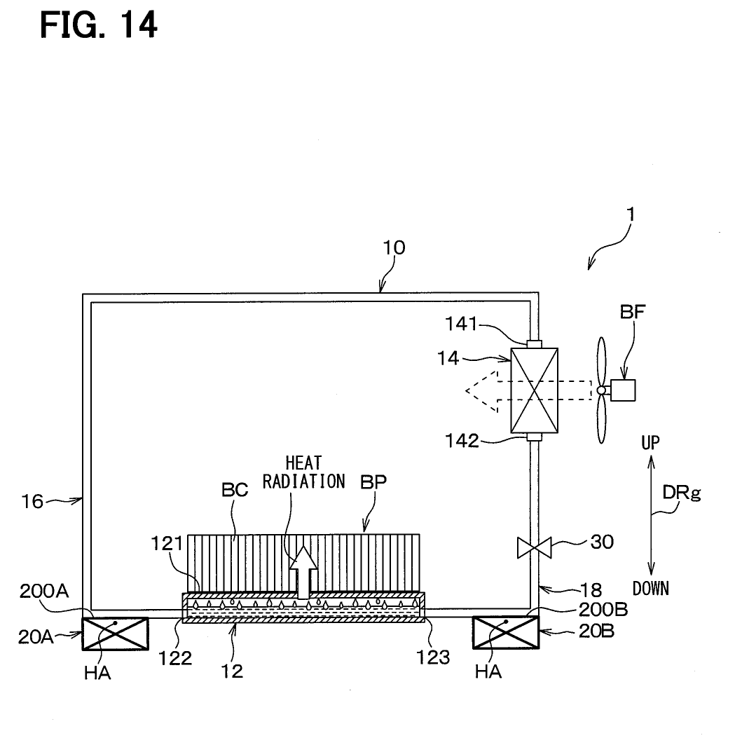

Further, the device temperature regulator 1 may be configured such that, for example, as shown in FIG. 14, neither of the gas passage part 16 nor the liquid passage part 18 is provided with the tank parts 161, 181. In this case, the heaters 20A, 20B should be arranged simply at portions on a lower side of each of the gas passage part 16 and the liquid passage part 18. The heat receiving portions 200A, 200B in the present modification are portions opposite to the heaters 20A, 20B in the gas passage part 16 and the liquid passage part 18.

### Seventh Modification

In the first embodiment described above, the blower fan BF has been shown as the heat radiation amount regulator for regulating a heat radiation amount of the working fluid collecting in the condenser 14, but the heat radiation amount regulator is not limited to the blower fan BF.

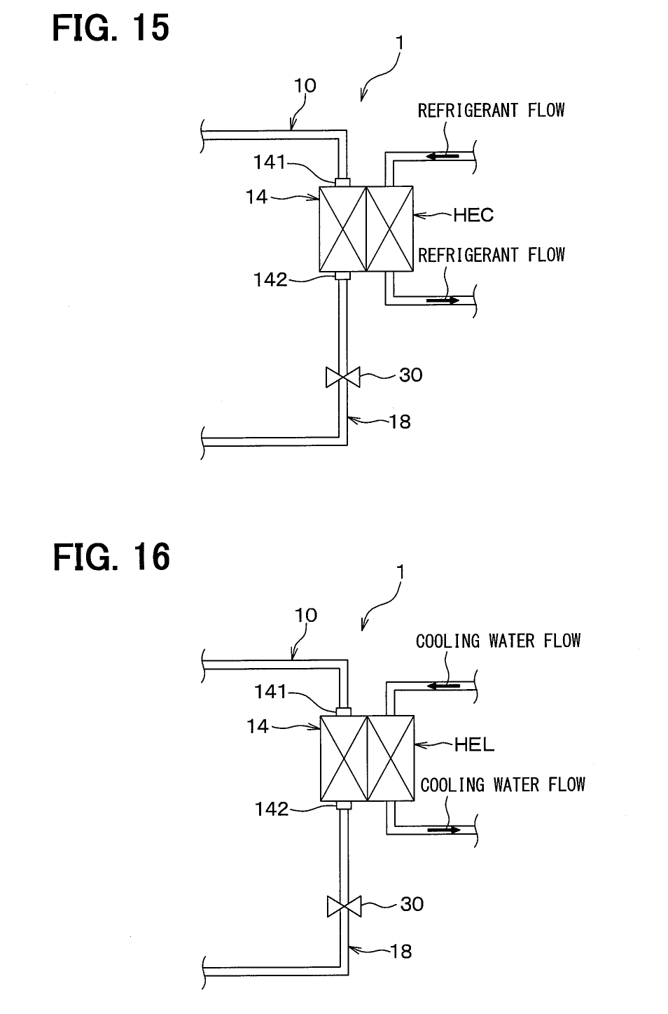

The heat radiation amount regulator, as shown in FIG. 15, may be configured of a refrigerant-side heat exchanger HEC in which the low-temperature refrigerant of a refrigeration cycle of a vapor compression type flows. In this case, the heat radiation amount in the condenser 14 is varied by increasing or decreasing the number of revolutions of a compressor in the refrigeration cycle. For this reason, in a case where the refrigerant-side heat exchanger HEC shown in FIG. 15 is made the heat radiation amount regulator, a configuration for controlling the number of revolutions of the compressor becomes a control part for controlling the heat radiation amount regulator.

### Eighth Modification

Further, the heat radiation amount regulator, as shown in FIG. 16, may be configured of a water-side heat exchanger HEL in which a low-temperature antifreeze flows in a cooling water circuit. In this case, the heat radiation amount in the condenser 14 is varied by increasing or decreasing the number of revolutions of a pump in the cooling water circuit. For this reason, in a case where the water-side heat exchanger HEL shown in FIG. 16 is made the heat radiation amount regulator, a configuration for controlling the number of revolutions of the pump becomes a control part for controlling the heat radiation amount regulator.

### Ninth Modification

In the first embodiment described above, an example in which the heat radiation amount in the condenser 14 is increased in a state where the supply of the liquid working fluid to the device heat exchanger 12 is stopped when the condition that requires the battery pack BP to be warmed up is satisfied has been described, but the present disclosure is not limited to this.

The device temperature regulator 1 of the present modification is configured so as to decrease the heat radiation amount of the working fluid in the condenser 14 when the condition that requires the battery pack BP to be warmed up is satisfied and when the condition in which the liquid amount of the working fluid in the device heat exchanger 12 becomes lower than a specified reference liquid amount is satisfied.

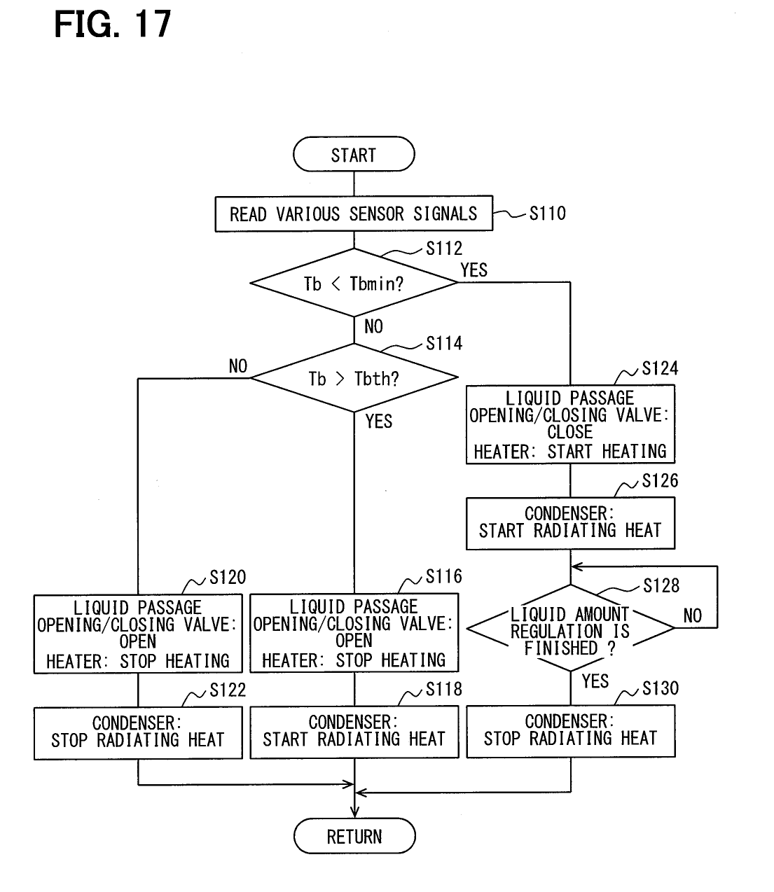

Hereinafter, an operation of the device temperature regulator 1 of the present modification will be described with reference to a flow chart shown in FIG. 17. Control processing shown in FIG. 17 is performed by the control device 100. Of the control processing shown in FIG. 17, the processing shown in steps S110 to S126 are the same as the processing shown in steps S110 to S126 shown in FIG. 5, which are described in the first embodiment. For this reason, in the present embodiments, as to the processing shown in steps S110 to S126, their descriptions will be omitted or simplified.

As shown in FIG. 17, the control device 100 operates the blower fan BF in step S126 to start the heat radiation of the working fluid collecting in the condenser 14 and then determines in step S128 whether or not a regulation of the liquid amount of the working fluid collecting in the device heat exchanger 12 is finished. In other words, the control device 100 determines in step S128 whether or not a condition in which the liquid amount of the working fluid in the device heat exchanger 12 becomes lower than a specified reference liquid amount is satisfied.

Specifically, when a specified reference time elapses after the control device 100 of the present modification operates the blower fan BF, the control device 100 determines in step S128 that the regulation of the liquid amount of the working fluid collecting in the device heat exchanger 12 is finished.

Here, the processing in step S128 may be processing for determining whether or not the regulation of the liquid amount of the working fluid collecting in the device heat exchanger 12 is finished regardless of an elapsed time from when the blower fan BF is operated in step S126.

For example, the control device 100 may be configured in the following manner: that is, the control device 100 operates the blower fan BF in step S126 and then when the battery temperature Tb of the battery pack BP increases to a specified temperature, the control device 100 determines that the regulation of the liquid amount of the working fluid collecting in the device heat exchanger 12 is finished.

Further, the control device 100 may be configured to monitor an actual liquid amount of the working fluid in the device heat exchanger 12, and the control device 100 may determine that the regulation of the liquid amount of the working fluid flowing in the device heat exchanger 12 is finished when the actual liquid amount becomes more than a specified reference amount.

In a case where it is determined in step S128 that the regulation of the liquid amount of the working fluid collecting in the device heat exchanger 12 is finished, the control device 100 stops operating the blower fan BF in step S130 to stop radiating the heat of the working fluid collecting in the condenser 14.

The other configuration is the same as the first embodiment. The device temperature regulator 1 of the present modification is configured so as to decrease the heat radiation amount of the working fluid in the condenser 14 when the condition that requires the battery pack BP to be warmed up is satisfied and when the condition in which the liquid amount of the working fluid in the device heat exchanger 12 becomes lower than the specified reference amount is satisfied. In other words, in the device temperature regulator 1 of the present modification, when the supply of the liquid working fluid to the device heat exchanger 12 is stopped and then the liquid amount of the working fluid in the device heat exchanger 12 becomes lower than the specified reference amount, the heat radiation amount of the working fluid in the condenser 14 is decreased.

In this configuration, the gaseous working fluid heated and evaporated by the heater 20 is limited from flowing into the condenser 14 side, so that the liquid amount of the working fluid in the device heat exchanger 12 can be held at a suitable amount.

### Second Embodiment

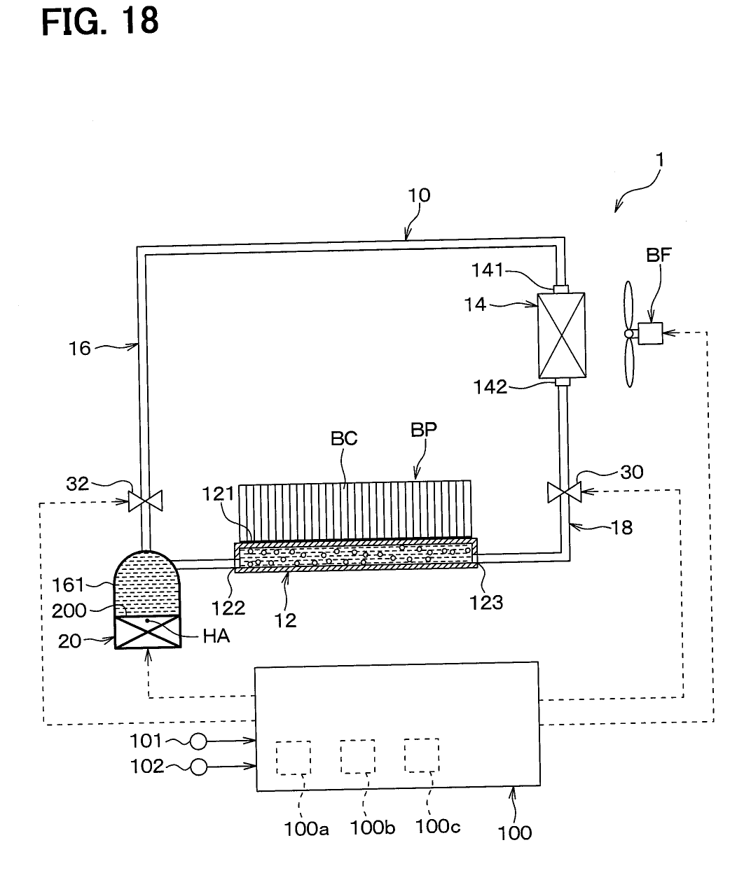

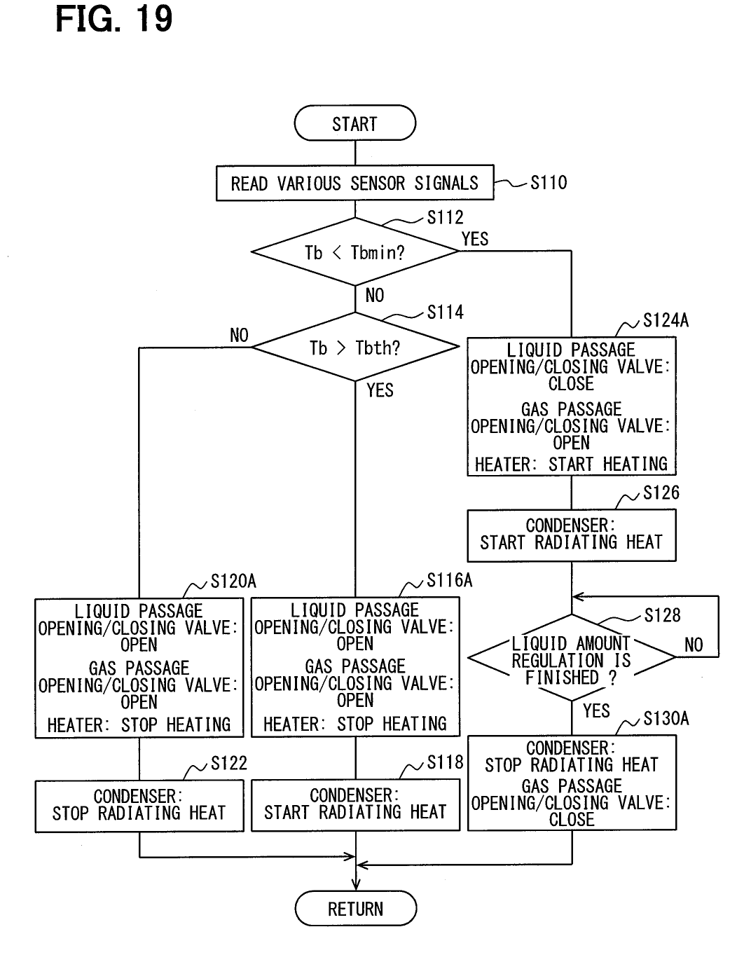

Next, a second embodiment will be described with reference to FIG. 18 and FIG. 19. The present embodiment is different from the first embodiment in that the device temperature regulator 1 is provided with a gas passage opening/closing valve 32 for opening or closing the gas passage part 16.

As shown in FIG. 18, in the device temperature regulator 1 of the present embodiment, the gas passage part 16 is provided with the gas passage opening/closing valve 32 for opening or closing the gas passage part 16. The gas passage opening/closing valve 32 is configured of an electric valve mechanism controlled by the control device 100. Specifically, the gas passage opening/closing valve 32 of the present embodiment is configured of an electromagnetic valve of a normal open type which is closed when energized and which is opened when not energized.

The gas passage opening/closing valve 32 of the present embodiment is provided at a portion closer to the condenser 14 side than the tank part 161 in the gas passage part 16 such that the gaseous working fluid heated and evaporated by the heater 20 does not flow into the condenser 14 via the gas passage part 16.

In the device heat exchanger 12 of the present embodiment, when the gas passage part 16 is opened by the gas passage opening/closing valve 32, the gaseous working fluid is supplied to the condenser 14, whereas when the gas passage part 16 is closed by the gas passage opening/closing valve 32, the supply of the gaseous working fluid to the condenser 14 is stopped.

Hereinafter, an operation of the device temperature regulator 1 of the present embodiment will be described with reference to a flow chart shown in FIG. 19. Control processing shown in FIG. 19 is performed by the control device 100. Of the control processing shown in FIG. 19, the processing shown in steps S110 to S114 are the same as the processing shown in steps S110 to S114 shown in FIG. 5, which are described in the first embodiment. For this reason, in the present embodiment, as to the processing shown in steps S110 to S114, their descriptions will be omitted or simplified.

As shown in FIG. 19, in a case where it is determined as a result of the determination processing in step S114 that the battery temperature Tb of the battery pack BP is higher than a temperature requiring cooling Tbth, the device temperature regulator 1 of the present modification proceeds to a cooling mode for cooling the battery pack BP. In other words, in the case where it is determined as a result of the determination processing in step S114 that the battery temperature Tb of the battery pack BP is higher than the temperature requiring cooling Tbth, the control device 100 opens the respective passage opening/closing valves 30, 32 in step S116A and stops the heating of the working fluid by the heater 20. Further, the control device 100 operates the blower fan BF in step S118 to start the heat radiation of the working fluid collecting in the condenser 14.

On the other hand, in a case where it is determined as the result of the determination processing in step S114 that the battery temperature Tb of the battery pack BP is the temperature requiring cooling Tbth or lower, the control device 100 opens the respective passage opening/closing valves 30, 32 in step S120A and stops the heating of the working fluid by the heater 20. Further, the control device 100 stops operating the blower fan BF in step S122 to stop the heat radiation of the working fluid collecting in the condenser 14.

Further, in a case where it is determined as a result of the determination processing in step S112 that the battery temperature Tb of the battery pack BP is the allowable lower limit temperature Tbmin or lower, the device temperature regulator 1 of the present embodiment proceeds to a warming-up mode. In other words, in step S124A, the control device 100 closes the liquid passage opening/closing valve 30 and opens the gas passage opening/closing valve 32 and then starts the heating of the working fluid by the heater 20. Then, in step S126, the control device 100 operates the blower fan BF to start the heat radiation of the working fluid in the condenser 14.

The control device 100 operates the blower fan BF in step S126 and then determines in step S128 whether or not the regulation of the liquid amount of the working fluid collecting in the device heat exchanger 12 is finished. In other words, the control device 100 determines in step S128 whether or not the condition in which the liquid amount of the working fluid collecting in the device heat exchanger 12 is lower than the specified reference liquid amount is satisfied.

In a case where it is determined in step S128 that the regulation of the liquid amount of the working fluid collecting in the device heat exchanger 12 is finished, the control device 100 stops the operation of the blower fan BF in step S130A to stop the heat radiation of the working fluid collecting in the condenser 14 and controls the gas passage opening/closing valve 32 to a closed state.

The other configuration is the same as the first embodiment. The device temperature regulator 1 of the present embodiment is configured so as to close the gas passage 16 by the gas passage opening/closing valve 32 when the condition that requires the battery pack BP to be warmed up is satisfied and the condition in which the liquid amount of the working fluid collecting in the device heat exchanger 12 is lower than the specified reference liquid amount is satisfied.

According to this, when the liquid amount of the working fluid in the device heat exchanger 12 becomes lower than the specified reference liquid amount, the gaseous working fluid heated and evaporated by the heater 20 is limited from flowing into the condenser 14 side. In this way, the liquid amount of the working fluid in the device heat exchanger 12 can be held at a suitable amount at the time of warming up the battery pack BP.

Further, after the gas passage part 16 is closed by the gas passage opening/closing valve 32, almost all of the heat amount from the heater 20 is used for warming up the battery pack BP, so that an energy efficiency at the time of warming up the battery pack BP can be improved.

### Third Embodiment

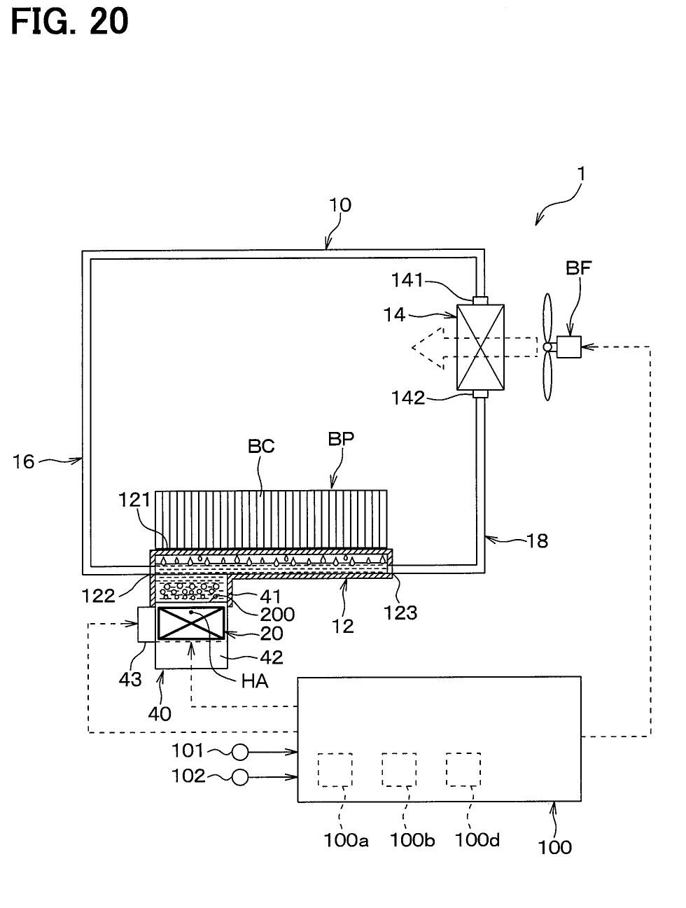

Next, a third embodiment will be described with reference to FIG. 20 to FIG. 22. The present embodiment is different from the first embodiment in that the liquid amount regulator, which regulates the liquid amount of the working fluid collecting in the device heat exchanger 12, is not configured of the liquid passage opening/closing valve 30 but is configured of a volume regulation part 40 which regulates an internal volume of the device fluid circuit 10.

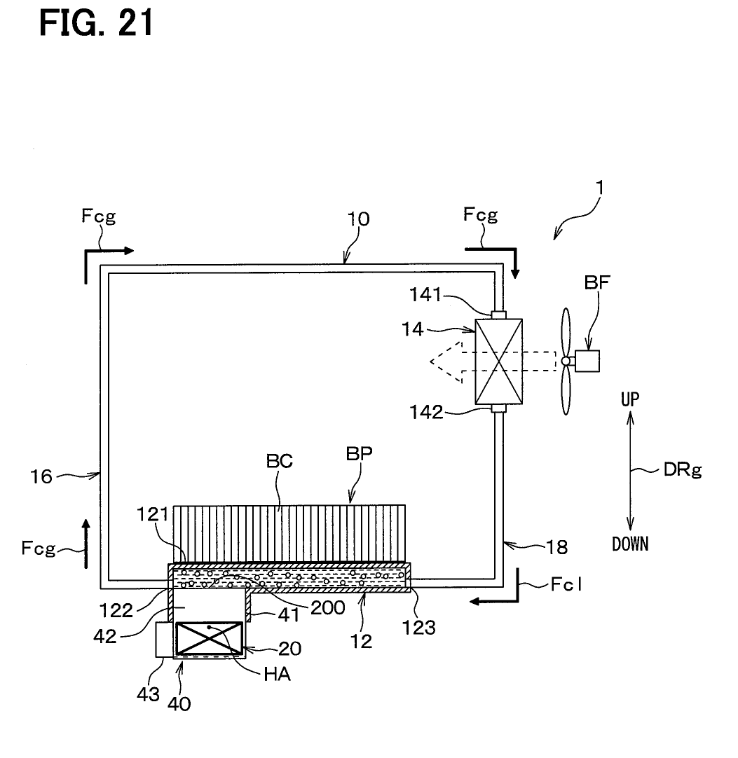

As shown in FIG. 20 and FIG. 21, the device temperature regulator 1 of the present embodiment is provided with the volume regulation part 40 so as to regulate the liquid amount of the working fluid in the device heat exchanger 12. The device temperature regulator 1 of the present embodiment is not provided with the liquid passage opening/closing valve 30.

The volume regulation part 40 of the present embodiment is provided with a liquid reservoir 41 for storing the liquid working fluid, a volume variation part 42 which slides in the liquid reservoir to thereby vary an internal volume of the liquid reservoir 41, and an actuator 43 for driving the volume variation part 42.

The liquid reservoir 41 of the present embodiment is provided in a lower portion of the device heat exchanger 12. Specifically, the liquid reservoir 41 of the present embodiment is configured of a portion formed by bulging a portion of the device heat exchanger 12 to a lower side.

The liquid reservoir 41 of the present embodiment is provided on a lower side of the device proximity part 121 of the device heat exchanger 12. Specifically, the liquid reservoir 41 of the present embodiment is provided on a lower side of the device proximity part 121 in the device heat exchanger 12 and on a lower side of both of the gas outlet part 122 and the liquid inlet part 123 in the vertical direction DRg.

The volume variation part 42 of the present embodiment is configured of a block-shaped member located on a lower side of the liquid reservoir 41. The actuator 43 changes a position of the volume variation part 42 in the liquid reservoir 41 to thereby increase or decrease the internal volume of the liquid reservoir 41.

Specifically, the volume regulation part 40 is configured such that when the volume variation part 42 is moved to an uppermost position by the actuator 43, the internal volume of the liquid reservoir 41 becomes substantially zero. Further, the volume regulation part 40 is configured such that when the volume variation part 42 is moved to a lowermost position by the actuator 43, the internal volume of the liquid reservoir 41 becomes a maximum volume. The volume regulation part 40 of the present embodiment has its operation controlled by the control device 100.

In the device temperature regulator 1 of the present embodiment, the liquid amount of the working fluid collecting in the device heat exchanger 12 is increased or decreased by changing a position of the volume variation part 42 to increase or decrease a liquid storage amount of the working fluid in the liquid reservoir 41.

Specifically, in the device temperature regulator 1 of the present embodiment, when the internal volume of the liquid reservoir 41 is decreased, the liquid amount of the working fluid colleting in the device heat exchanger 12 is increased. Further, in the device temperature regulator 1 of the present embodiment, when the internal volume of the liquid reservoir 41 is increased, the liquid amount of the working fluid colleting in the device heat exchanger 12 is decreased.

In this way, in the device temperature regulator 1 of the present embodiment, the volume regulation part 40 functions as a liquid amount regulator that regulates the liquid amount of the working fluid collecting in the device heat exchanger 12. The volume regulation part 40 described in the present embodiment is only an example and may be realized by the other configuration.

The volume regulation part 40 of the present embodiment has its maximum volume set such that the liquid surface of the working fluid in the device heat exchanger 12 when the liquid working fluid is stored in the liquid reservoir 41 is positioned between the device proximity part 121 and the heat radiation portion HA of the heater 20 in the vertical direction DRg.

In this way, the volume regulation part 40 can regulate the liquid amount of the working fluid in the device heat exchanger 12 such that, at the time of warming up the battery pack BP, the liquid surface of the working fluid in the device heat exchanger 12 is located between the device proximity part 121 and the heat radiation portion HA of the heater 20 in the vertical direction DRg.

The volume regulation part 40 of the present embodiment is configured so as to regulate the liquid amount of the working fluid in the device heat exchanger 12 such that, at the time of warming up the battery pack BP, an occupancy rate of the gaseous working fluid inside the device proximity part 121 becomes larger as compared with at the time of cooling the battery pack BP.

The volume regulation part 40 of the present embodiment is configured so as to regulate the liquid amount of the working fluid collecting in the device heat exchanger 12 such that, at the time of warming up the battery pack BP, the liquid working fluid collects at least in a portion of the heat receiving portion 200 receiving heat from the heater 20.

Specifically, the volume regulation part 40 is configured so as to regulate the liquid amount of the working fluid in the device heat exchanger 12 such that, at the time of warming up the battery pack BP, the liquid surface of the working fluid in the device heat exchanger 12 is located above at least one of gas outlet part 122 and the liquid inlet part 123.

The heater 20 of the present embodiment is located at a position close to the liquid reservoir 41 such that the working fluid collecting in the liquid reservoir 41 of the volume regulation part 40 is heated. Specifically, the heater 20 of the present embodiment is located on a lower surface part of the liquid reservoir 41 of the volume regulation part 40. The heat receiving portion 200 of the present embodiment becomes the lower surface part of the liquid reservoir 41.

Subsequently, the control device 100 of the device temperature regulator 1 of the present embodiment will be described with reference to FIG. 20. The control device 100 controls the operations of various kinds of instruments connected to an output side thereof, for example, the blower fan BF and the volume regulation part 40. Not only a fan control part 100a for controlling the number of revolutions of the blower fan BF but also a volume control part 100d for controlling an operation of the volume regulation part 40 are integrated into the control device 100 of the present embodiment.

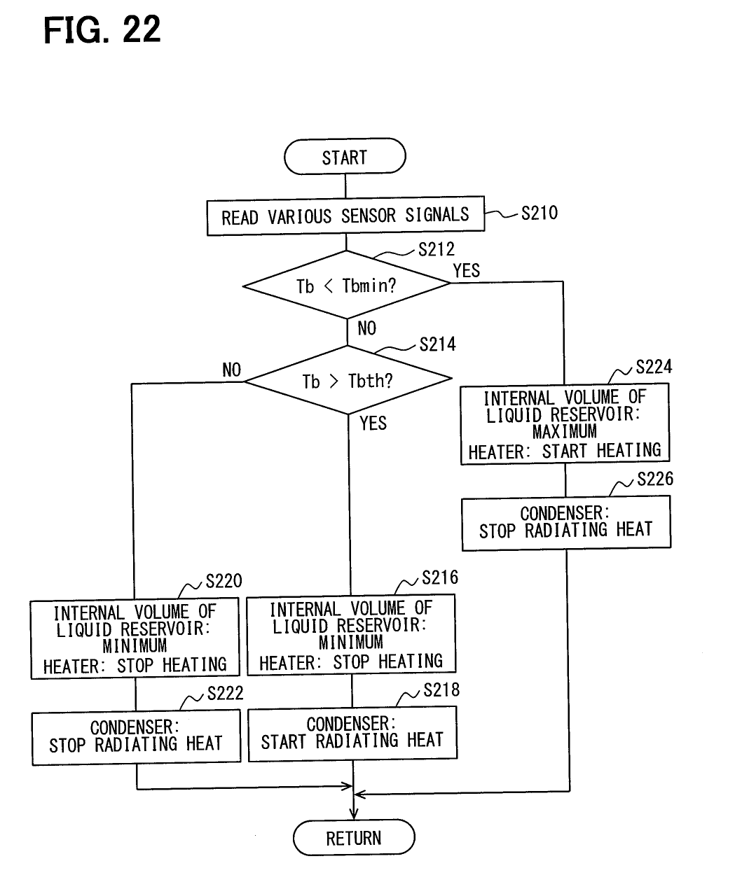

The other configuration is the same as the first embodiment. Hereinafter, an operation of the device temperature regulator 1 of the present embodiment will be described with reference to a flow chart shown in FIG. 22. Control processing shown in FIG. 22 is performed by the control device 100 at a specified period. Of the control processing shown in FIG. 22, the processing shown in steps S210 to S214 are the same as the processing shown in steps S110 to S114 shown in FIG. 5, which are described in the first embodiment. For this reason, in the present embodiment, as to the processing shown in steps S210 to S214, their descriptions will be omitted or simplified.

As shown in FIG. 22, first, the control device 100 reads various sensor signals in step S210. Subsequently, the control device 100 determines in step S212 whether or not the battery temperature Tb of the battery pack BP is lower than the previously set allowable lower limit temperature Tbmin of the battery pack BP.

In a case where it is determined as a result of the determination processing of step S212 that the battery temperature Tb of the battery pack BP is the allowable lower limit temperature Tbmin or more, the control device 100 determines in step S214 whether or not the battery temperature Tb of the battery pack BP is higher than the previously set temperature requiring cooling Tbth.

In a case where it is determined as a result of the determination processing of step S214 that the battery temperature Tb of the battery pack BP is higher than the temperature requiring cooling Tbth, the device temperature regulator 1 proceeds to the cooling mode for cooling the battery pack BP. In other words, in step S216, the control device 100 minimizes the internal volume of the liquid reservoir 41 of the volume regulation part 40 and stops heating the working fluid by the heater 20. Further, in step 218, the control device 100 operates the blower fan BF to start the heat radiation of the working fluid collecting in the condenser 14. Specifically, in the processing of step S216, the control device 100 controls the position of the volume variation part 42 such that the internal volume of the liquid reservoir 41 becomes a minimum volume.

In the device temperature regulator 1, when the battery temperature Tb of the battery pack BP is increased by self-heating or the like when the vehicle travels, the heat of the battery pack BP is transferred to the device heat exchanger 12. In the device heat exchanger 12, heat is absorbed from the battery pack BP and hence a portion of the liquid working fluid is evaporated. The battery pack BP is cooled by a latent heat of evaporation of the working fluid collecting in the device heat exchanger 12 and hence has its temperature decreased. At this time, since the internal volume of the liquid reservoir 41 is minimized, the liquid working fluid is evaporated near the device proximity part 121 in the device heat exchanger 12.

The gaseous working fluid evaporated in the device heat exchanger 12 flows out to the gas passage part 16 from the gas outlet part 122 of the device heat exchanger 12 and moves to the condenser 14 via the gas passage part 16 as shown by an arrow Fcg of FIG. 21.

In the condenser 14, heat is radiated to air blown from the blower fan BF, and the gaseous working fluid is thereby condensed. In the condenser 14, the gaseous working fluid is liquefied and a specific gravity of the working fluid is increased. In this way, the working fluid liquefied in the condenser 14 goes down toward a liquid outlet part 142 of the condenser 14 by its own weight.

The liquid working fluid condensed in the condenser 14 flows out to the liquid passage part 18 from the liquid outlet part 142 of the condenser 14 and moves to the device heat exchanger 12 via the liquid passage part 18 as shown by an arrow Fc1 of FIG. 21.

In this way, at the time of the cooling mode, in the device temperature regulator 1, the working fluid is circulated between the device heat exchanger 12 and the condenser 14 while changing the phase between the gas state and the liquid state and heat is transferred from the device heat exchanger 12 to the condenser 14, and thereby the battery pack BP is cooled.

Here, at the time of the cooling mode, the internal volume of the liquid reservoir 41 of the volume regulation part 40 is minimized, so that the internal space of the device heat exchanger 12 is filled with the liquid working fluid containing bubbles. In other words, at the time of the cooling mode, the liquid working fluid is in contact with an inside of the device proximity part 121 of the device heat exchanger 12. For this reason, at the time of the cooling mode, the battery pack BP can be sufficiently cooled by a heat adsorption effect produced by the evaporation of the liquid working fluid collecting in the device heat exchanger 12.

Returning to FIG. 22, in a case where it is determined as a result of the determination processing of step S214 that the battery temperature Tb of the battery pack BP is the temperature requiring cooling Tbth or lower, the device temperature regulator 1 stops the heat radiation of the working fluid in the condenser 14.

Specifically, in step S220, the control device 100 minimizes the internal volume of the liquid reservoir 41 and stops heating the working fluid by the heater 20. Further, in step S222, the control device 100 stops the operation of the blower fan BF to thereby stop the heat radiation of the working fluid collecting in the condenser 14.

In the device temperature regulator 1, in a case where even if the operation of the blower fan BF is stopped, when the temperature of the working fluid collecting in the condenser 14 is higher than the battery temperature Tb of the battery pack BP, the heat is transferred to the condenser 14 from the device heat exchanger 12 and hence the battery pack BP is cooled.

Here, if the battery temperature Tb of the battery pack BP becomes lower than the allowable lower limit temperature Tbmin, the device temperature regulator 1 of the present embodiment proceeds to the warming-up mode so as to prevent the battery pack BP from being excessively cooled. In other words, in a case where it is determined as a result of the determination processing of step S212 that the battery temperature Tb of the battery pack BP is lower than the allowable lower limit temperature Tbmin, the control device 100 maximizes the internal volume of the liquid reservoir 41 and starts heating the working fluid by the heater 20 in step S224. Then, in step S226, the control device 100 stops operating the blower fan BF to thereby stop the heat radiation of the working fluid collecting in the condenser 14. Specifically, in the processing of step S224, the control device 100 controls the volume variation part 42 so as to maximize the internal volume of the liquid reservoir 41.

In the device temperature regulator 1, at the time of the warming-up mode, the internal volume of the liquid reservoir 41 becomes the maximum volume. For this reason, in the device temperature regulator 1, as shown in FIG. 20, the liquid surface of the working fluid in the device heat exchanger 12 goes down to a lower side of the device proximity part 121. In other words, in the device temperature regulator 1 of the present embodiment, the internal volume of the liquid reservoir 41 is maximized at the time of the warming-up mode, so that the occupancy rate of the gaseous working fluid inside the device proximity part 121 of the device heat exchanger 12 becomes larger as compared with at the time of the cooling mode.

In addition, in the device temperature regulator 1 of the present embodiment, even if the internal volume of the liquid reservoir 41 is maximized, the liquid working fluid collects in the heat receiving portion 200 to receive the heat from the heater 20. For this reason, in the device temperature regulator 1, the working fluid heated and evaporated by the heater 20 is condensed near the device proximity part 121 of the device heat exchanger 12. In other words, in the device temperature regulator 1, at the time of the warming-up mode, the working fluid is condensed near the device proximity part 121 of the device heat exchanger 12 and the heat of the working fluid at that time is radiated to the battery pack BP and hence the battery pack BP is heated.

The device temperature regulator 1 of the present embodiment described above can produce the same operations and effects produced by the configuration common to the first embodiment as is the case with the first embodiment. In particular, the device temperature regulator 1 of the present embodiment is configured so as to increase the internal volume of the device fluid circuit 10 by the volume regulation part 40 when the condition that requires the battery pack BP to be warmed up is satisfied.

In this way, if the device temperature regulator 1 of the present embodiment is configured to increase the internal volume of the device fluid circuit 10 at the time of warming up the battery pack BP, the liquid working fluid is stored in a space increased by the volume regulation part 40 and hence the liquid amount of the working fluid in the device heat exchanger 12 can be decreased. In other words, in the device temperature regulator 1 of the present embodiment, the occupancy rate of the gaseous working fluid inside the device proximity part 121 of the device heat exchanger 12 can be made larger at the time of the warming-up mode as compared with at the time of the cooling mode by the volume regulation part 40.

According to this, at the time of warming up the battery pack BP, the gaseous working fluid evaporated by the heater 20 can be condensed by the device proximity part 121 proximate to the battery pack BP, so that the heat of the working fluid can be radiated to the battery pack BP via the device heat exchanger 12. As a result, in the warming up of the battery pack BP, the battery pack BP comes close to a portion in which the gaseous working fluid in the device heat exchanger 12 collects, so that the temperature variation of the battery pack BP can be sufficiently limited.

In particular, at the time of warming up the battery pack BP, an area in which the gaseous working fluid evaporated by the heater 20 is in contact with the gaseous working fluid at an inside portion of the device proximity part 121, exchanging heat with the battery pack BP, is increased, thereby increasing a range in which gaseous working fluid inside the device proximity part 121 is condensed.

Thus, according to the device temperature regulator 1 of the present embodiment, at the time of warming up the battery pack BP, the battery pack BP can be heated in a wide range, so that the temperature variation of the battery pack BP can be sufficiently limited.

Further, at the time of cooling the battery pack BP, the area in which the liquid working fluid is in contact with the inside portion to exchange heat with the battery pack BP in the device heat exchanger 12 is increased, so that the liquid working fluid can be evaporated on the inside of the device proximity part 121. According to this, the battery pack BP can be sufficiently cooled by the heat absorption effect produced by the evaporation of the liquid working fluid.

Further in the device temperature regulator 1 of the present embodiment, the liquid reservoir 41 of the variable volume type in which the internal volume can be varied is provided on the lower side of the device proximity part 121 of the device heat exchanger 12 in the vertical direction DRg. According to this, the liquid working fluid collecting in the device heat exchanger 12 can easily flow to the liquid reservoir 41 by its own weight, so that the liquid amount of the working fluid in the device heat exchanger 12 can be suitably reduced at the time of warming up the battery pack BP.

Specifically, in the device temperature regulator 1 of the present embodiment, the liquid reservoir 41 is provided on the lower side of at least one of the gas outlet part 122 and the liquid inlet part 123 in the device heat exchanger 12 in the vertical direction DRg. According to this, the liquid working fluid collecting in the device heat exchanger 12 can easily flow into the liquid reservoir 41, so that the liquid working fluid can be transferred to the liquid reservoir 41 from the device heat exchanger 12 at the time of warming up the battery pack BP.

Further, in the device temperature regulator 1 of the present embodiment, the heater 20 is located on the lower side of the liquid reservoir 41 in the vertical direction DRg. According to this, the gaseous working fluid heated and evaporated by the heater 20 can easily flow to the device heat exchanger 12 side from the liquid reservoir 41, so that the heat of the working fluid can be transferred to the battery pack BP via the device heat exchanger 12.

### Modification of the Third Embodiment

In the third embodiment described above, the configuration in which the liquid reservoir 41 of the volume regulation part 40 is provided on the lower side of the device heat exchanger 12 has been shown, but the present disclosure is not limited to this.

The device temperature regulator 1, for example, as shown in FIG. 23, may be configured such that a liquid reservoir 41A is provided on a portion on the lower side of the gas passage part 16. In this case, it is preferable that the liquid reservoir 41A is provided on the lower side of the device proximity part 121 in the device heat exchanger 12.

Although not shown in the figure, the device temperature regulator 1 may be configured such that the liquid reservoir 41 is provided on a portion on the lower side of the liquid passage part 18. In this case, it is preferable that the liquid reservoir 41 is provided on the lower side of the device proximity part 121 in the device heat exchanger 12.

### Fourth Embodiment

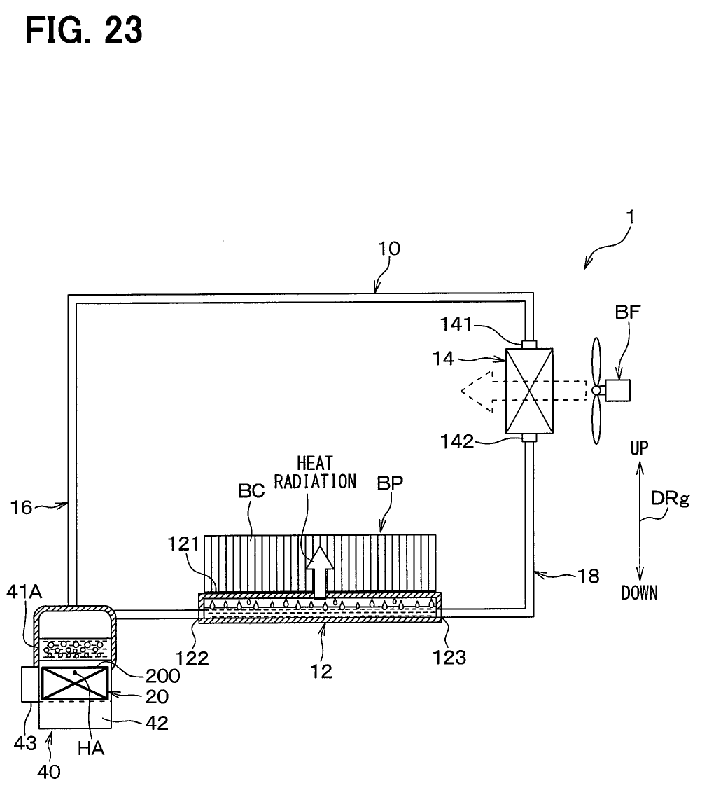

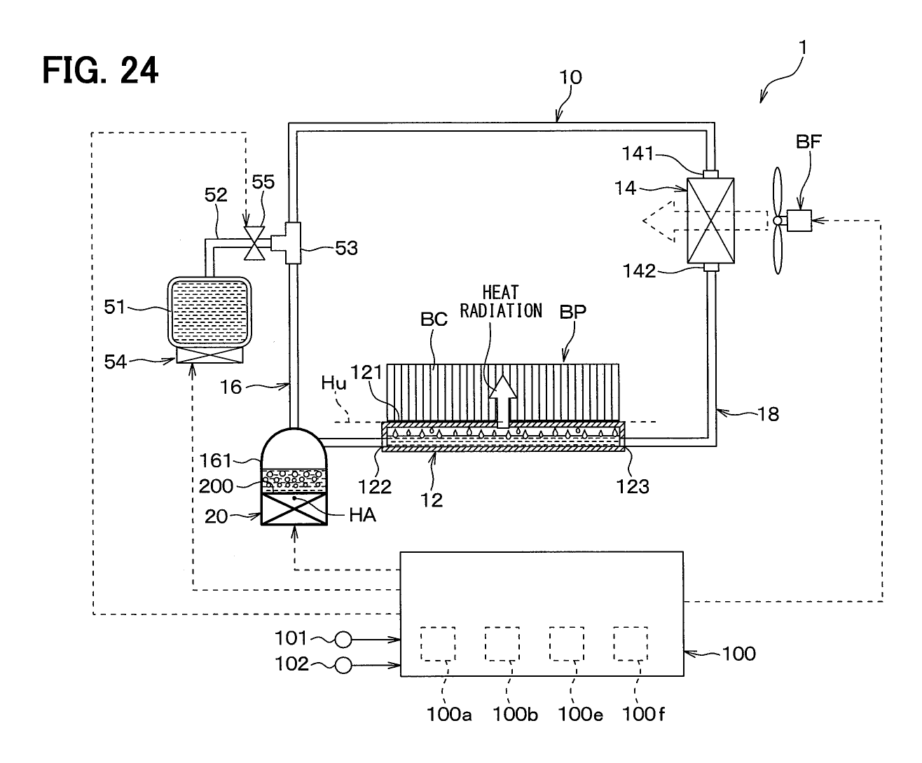

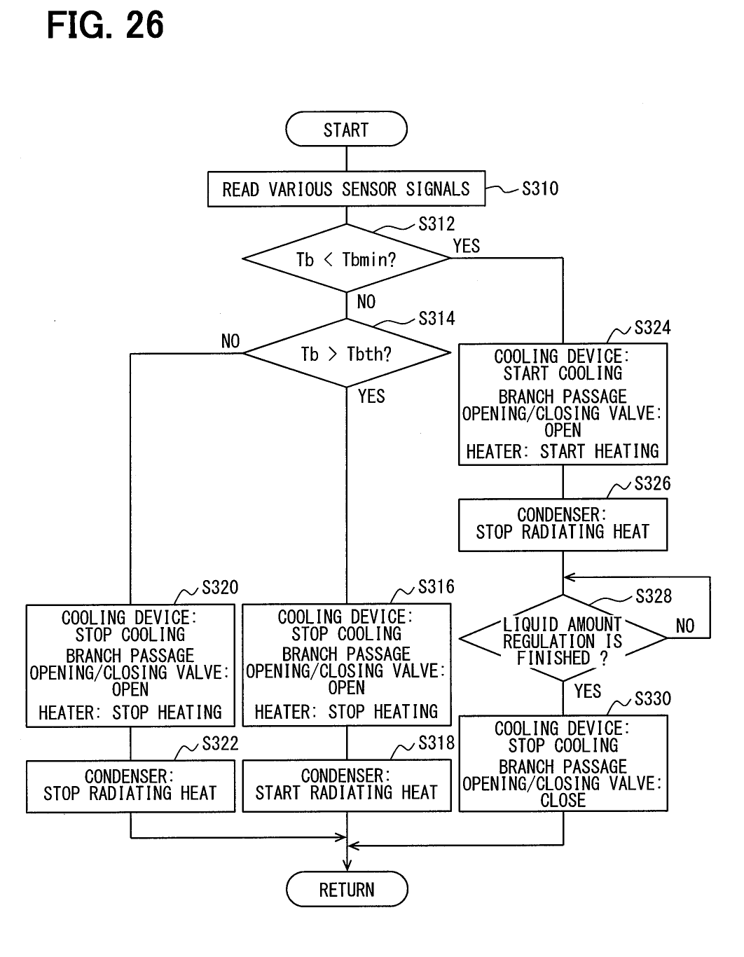

Next, a fourth embodiment will be described with reference to FIG. 24 and FIG. 26. The present embodiment is different from the first embodiment in that the liquid amount regulator for regulating the liquid amount of the working fluid collecting in the device heat exchanger 12 includes not the liquid passage opening/closing valve 30 but a liquid reservoir 51 and a cooling device 54.

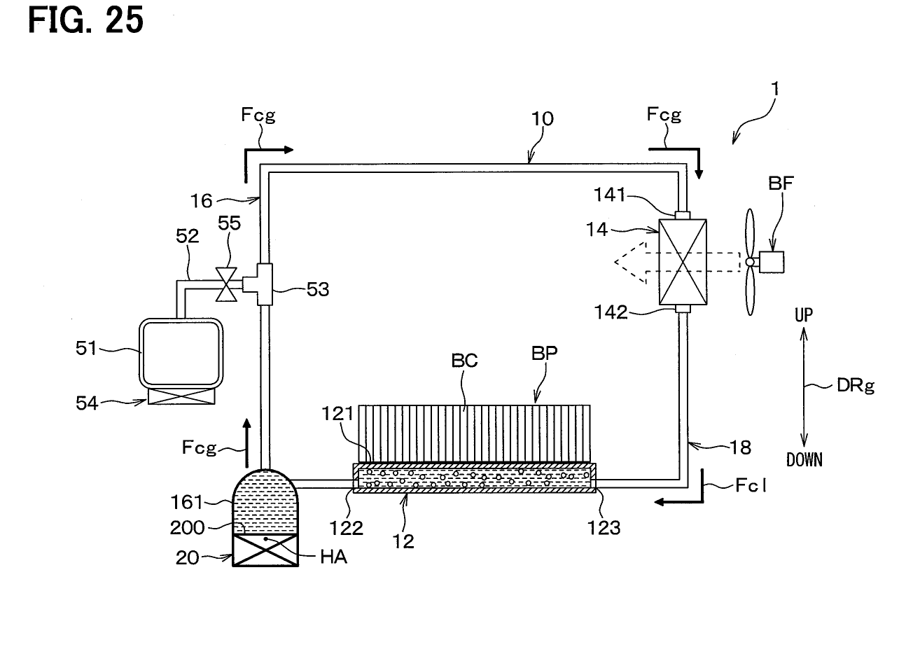

As shown in FIG. 24 and FIG. 25, the device temperature regulator 1 of the present embodiment is provided with the liquid reservoir 51, a branch passage part 52, a branch connection part 53, the cooling device 54, and a branch passage opening/closing valve 55 so as to regulate the liquid amount of the working fluid collecting in the device heat exchanger.

The liquid reservoir 51 stores the liquid working fluid collecting in the device fluid circuit 10. The liquid reservoir 51 is configured of a fixed-volume type container having a constant internal volume. The liquid reservoir 51 is connected to the device fluid circuit 10 via the branch passage part 52 and the branch connection part 53. Specifically, the liquid reservoir 51 is connected to the gas passage part 16 of the device fluid circuit 10 via the branch passage part 52 and the branch connection part 53.

The branch connection part 53 is configured of a three-way joint provided in the device fluid circuit 10. The branch connection part 53 of the present embodiment is provided at a portion located on an upper side of a portion Hu located uppermost in the vertical direction DRg of the device heat exchanger 12 of the device fluid circuit 10. Further, the branch passage part 52 has its one end side connected to an upper surface part of the liquid reservoir 51 and has the other end side connected to the branch connection part 53.

The cooling device 54 is a device which cools the liquid reservoir 51 to condense the gaseous working fluid collecting in the liquid reservoir 51. The cooling device 54 is provided next to a lower surface part of the liquid reservoir 51.

The cooling device 54 of the present embodiment is configured of a Peltier element to generate cold heat when energized. The cooling device 54 has its operation controlled by the control device 100. The cooling device 54 may be configured of not only the Peltier element but also, for example, a heat exchanger in which a low-temperature refrigerant of a refrigeration cycle of a vapor compression type is circulated.

Here, the gaseous working fluid collecting in the device fluid circuit 10 is condensed at a portion brought into a low temperature in the device fluid circuit 10. For this reason, when the liquid reservoir 51 is cooled by the cooling device 54, the gaseous working fluid collecting in the device fluid circuit 10 is condensed and stored in the liquid reservoir 51.

For this reason, in the device temperature regulator 1, when the liquid reservoir 51 is cooled by the cooling device 54, the liquid amount of the working fluid collecting in the device fluid circuit 10 is decreased. Then, in the device heat exchanger 12, as the liquid amount of the working fluid in the device fluid circuit 10 is decreased, the liquid amount of the working fluid in the device heat exchanger 12 is also decreased.

On the other hand, when the cooling of the liquid reservoir 51 by the cooling device 54 is stopped, the liquid working fluid stored in the liquid reservoir 51 is transferred to the device fluid circuit 10 as the temperature is increased, so that the liquid amount of the working fluid collecting in the device fluid circuit 10 is increased. As the liquid amount of the working fluid collecting in the device fluid circuit 10 is increased, the liquid amount of the working fluid collecting in the device heat exchanger 12 is also increased.

The cooling device 54 of the present embodiment is configured so as to increase the liquid storage amount of the liquid working fluid in the liquid reservoir 41 such that when the condition that requires the battery pack BP to be warmed up is satisfied, the liquid surface of the working fluid in the device heat exchanger 12 is located on the lower side of the device proximity part 121.

In the device temperature regulator 1 of the present embodiment, a maximum volume of the liquid reservoir 51 is set such that, when the liquid reservoir 51 stores the liquid working fluid, the liquid surface of the working fluid in the device heat exchanger 12 is located between the device proximity part 121 and the heat radiation portion HA of the heater 20 in the vertical direction DRg.

In other words, the device temperature regulator 1 can regulate the liquid amount of the working fluid in the device heat exchanger 12 such that at the time of warming up the battery pack BP, the liquid surface of the working fluid in the device heat exchanger 12 is located between the device proximity part 121 and the heat radiation portion HA of the heater 20 in the vertical direction DRg.

The device temperature regulator 1 of the present embodiment regulates the liquid amount of the working fluid in the device heat exchanger 12 such that at the time of warming up the battery pack BP, the occupancy rate of the gaseous working fluid inside the portion to exchange heat with the battery pack BP of the device heat exchanger 12 becomes larger as compared with at the time of cooling the battery pack BP.

Further, the device temperature regulator 1 of the present embodiment is configured so as to regulate the liquid amount of the working fluid collecting in the device heat exchanger 12 such that at the time of warming up the battery pack BP, the liquid working fluid collects in at least one portion of the heat receiving portion 200 to receive heat from the heater 20.

Specifically, the device temperature regulator 1 of the present embodiment can regulate the liquid amount of the working fluid in the device heat exchanger 12 such that at the time of warming up the battery pack BP, the liquid surface of the liquid working fluid in the device heat exchanger 12 is located above at least one of the gas outlet part 122 and the liquid inlet part 123.

Subsequently, the branch passage opening/closing valve 55 is a fluid shutter to shut a movement of the working fluid between the liquid reservoir 51 and the device fluid circuit 10. The branch passage opening/closing valve 55 of the present embodiment is provided in the branch passage part 52. The branch passage opening/closing valve 55 of the present embodiment is configured of an electric valve mechanism controlled by the control device 100. Specifically, the branch passage opening/closing valve 55 of the present embodiment is configured of a normally-open type electromagnetic valve which is closed when energized and is opened when not energized.

Subsequently, the control device 100 of the device temperature regulator 1 of the present embodiment will be described with reference to FIG. 24. The control device 100 controls the operations of various devices connected to its outside such as the blower fan BF, the cooling device 54, and the branch passage opening/closing valve 55. The control device 100 of the present embodiment has not only a BF control part 100a but also a cooling control part 100e and a valve control part 100f integrated thereinto, the fan control part 100a controlling the number of revolutions of the blower fan BF, the cooling control part 100e controlling an operation of the cooling device 54, the valve control part 100f controlling the branch passage opening/closing valve 55.

The other configuration is the same as the first embodiment. Hereinafter, an operation of the device temperature regulator 1 of the present embodiment will be described with reference to a flow chart shown in FIG. 26. Control processing shown in FIG. 26 is performed at a specified period by the control device 100. Of the control processing shown in FIG. 26, the processing shown in steps S310 to S314 are the same as the processing shown in steps S110 to S114 shown in FIG. 5, which are described in the first embodiment. For this reason, in the present embodiment, as to the processing shown in steps S310 to S314, their descriptions will be omitted or simplified.

As shown in FIG. 26, first, the control device 100 reads various sensor signals in step S310. Subsequently, the control device 100 determines in step S312 whether or not the battery temperature Tb of the battery pack BP is lower than the previously set allowable lower limit temperature Tbmin of the battery pack BP.

In a case where it is determined as a result of the determination processing of step S312 that the battery temperature Tb of the battery pack BP is the allowable lower limit temperature Tbmin or more, the control device 100 determines in step S314 whether or not the battery temperature Tb of the battery pack BP is higher than the previously set temperature requiring cooling Tbth.

In a case where it is determined as a result of the determination processing of step S314 that the battery temperature Tb of the battery pack BP is higher than the temperature requiring cooling Tbth, the device temperature regulator 1 proceeds to the cooling mode for cooling the battery pack BP. In other words, in step S316, the control device 100 stops cooling the liquid reservoir 51 by the cooling device 54 and controls the branch passage opening/closing valve 55 to an open state and further stops heating the working fluid by the heater 20. Further, in step 318, the control device 100 operates the blower fan BF to start the heat radiation of the working fluid collecting in the condenser 14.

In the device temperature regulator 1, at the time of the cooling mode, when the battery temperature Tb of the battery pack BP is increased by the self-heating developed when the vehicle is travelling, the heat of the battery pack BP is transferred to the device heat exchanger 12. In the device heat exchanger 12, heat is absorbed from the battery pack BP and hence a portion of the liquid working fluid is evaporated. The battery pack BP is cooled by a latent heat of evaporation of the working fluid collecting in the device heat exchanger 12, thereby having its temperature cooled.

The gaseous working fluid evaporated in the device heat exchanger 12 flows out to the gas passage part 16 from the gas outlet part 122 of the device heat exchanger 12 and moves to the condenser 14 via the gas passage part 16 as shown by arrows Fcg of FIG. 25.

The condenser 14 radiates heat to the air blown from the blower fan BF, and thereby the gaseous working fluid is condensed. In the condenser 14, the gaseous working fluid is liquefied to increase a specific gravity of the working fluid. In this way, the working fluid liquefied in the condenser 14 goes down to the liquid outlet part 142 of the condenser 14 by its own weight.

The liquid working fluid condensed in the condenser 14 flows out to the liquid passage part 18 from the liquid outlet part 142 of the condenser 14 and moves to the device heat exchanger 12 via the liquid passage part 18 as shown by an arrow Fc1. At the time of the cooling mode, the cooling of the liquid reservoir 51 by the cooling device 54 is stopped, so that the working fluid is hardly condensed in the liquid reservoir 51.

In this way, in the device temperature regulator 1, at the time of the cooling mode, the working fluid is circulated between the device heat exchanger 12 and the condenser 14 while changing its phase between the gas state and the liquid state and heat is transferred from the device heat exchanger 12 to the condenser 14, and thereby the battery pack BP is cooled.

Here, at the time of the cooling mode, the liquid working fluid is hardly stored in the liquid reservoir 51, so that an internal space of the device heat exchanger 12 is filled with the liquid working fluid containing bubbles. In other words, at the time of the cooling mode, the liquid working fluid is brought into contact with an inside of the device proximity part 121 of the device heat exchanger 12. For this reason, at the time of the cooling mode, the battery pack BP can be sufficiently cooled by a heat absorption effect produced by the evaporation of the liquid working fluid collecting in the device heat exchanger 12.

Returning to FIG. 26, in a case where it is determined as the result of the determination processing of step S314 that the battery temperature Tb of the battery pack BP is the temperature requiring cooling Tbth or less, the device temperature regulator 1 stops the heat radiation of the working fluid in the condenser 14.

Specifically, in step S320, the control device 100 stops cooling the liquid reservoir 51 by the cooling device 54 and controls the branch passage opening/closing valve 55 to an open state and further stops heating the working fluid by the heater 20. Further, in step S322, the control device 100 stops operating the blower fan BF to stop the heat radiation of the working fluid collecting in the condenser 14.

In the device temperature regulator 1, even if the operation of the blower fan BF is stopped, when the temperature of the working fluid collecting in the condenser 14 is higher than the battery temperature Tb of the battery pack BP, the heat is transferred to the condenser 14 from the device heat exchanger 12, and thereby the battery pack BP is cooled.

When the battery temperature Tb of the battery pack BP becomes lower than the allowable lower limit temperature Tbmin, the device temperature regulator 1 of the present embodiment proceeds to the warming-up mode so as to prevent the battery temperature BP from being excessively cooled. In other words, in step S324, the control device 100 starts cooling the liquid reservoir 51 by the cooling device 54 and controls the branch passage opening/closing valve 55 to an open state and further starts heating the working fluid by the heater 20. Further, in step S326, the control device 100 stops operating the blower fan BF to stop the heat radiation of the working fluid collecting in the condenser 14.

In the device temperature regulator 1 of the present embodiment, at the time of the warming up-mode, the branch passage part 52 is opened by the branch passage opening/closing valve 55 and the cooling of the liquid reservoir 51 is started by the cooling device 54 in a state where the heating of the working fluid by the heater 20 is started. At this time, the control device 100 controls the cooling device 54 such that the temperature of the liquid reservoir 51 becomes lower than the temperature of the condenser 14.

In the device temperature regulator 1, when the liquid reservoir 51 is cooled by the cooling device 54, the gaseous working fluid collecting in the device fluid circuit 10 is condensed in the liquid reservoir 51. In this way, in the device temperature regulator 1, as shown in FIG. 24, the liquid working fluid condensed in the liquid reservoir 51 is stored in the liquid reservoir 51.

In the device temperature regulator 1, as the liquid working fluid stored in the liquid reservoir 51 is increased, the liquid working fluid collecting in the device heat exchanger 12 is decreased. In this way, in the device temperature regulator 1, the liquid surface of the working fluid in the device heat exchanger 12 goes down to the lower side of the device proximity part 121. In other words, in the device temperature regulator 1 of the present embodiment, the liquid working fluid is stored in the liquid reservoir 51 at the time of the warming-up mode, so that the occupancy rate of the gaseous working fluid inside the device proximity part 121 of the device heat exchanger 12 becomes larger compared with at the time of the cooling mode.

In addition, in the device temperature regulator 1 of the present embodiment, even if the liquid working fluid is stored in the liquid reservoir 51, the liquid working fluid collects at the heat receiving portion 200 to receive the heat from the heater 20. For this reason, in the device temperature regulator 1, the working fluid heated and evaporated by the heater 20 is condensed near the device proximity part 121 of the device heat exchanger 12. In short, in the device temperature regulator 1, at the time of the warming-up mode, the working fluid is condensed near the device proximity part 121 of the device heat exchanger 12 and the heat of the working fluid at that time is radiated to the battery pack BP, and thereby the battery pack BP is heated.

Returning to FIG. 26, after the processing of step S326, the control device 100 determines in step S328 whether or not the regulation of the liquid amount of the working fluid collecting in the device heat exchanger 12 is finished. In other words, the control device 100 determines in step S328 whether or not the condition in which the liquid amount of the working fluid in the device heat exchanger 12 becomes lower than a specified reference liquid amount is satisfied.

When a specified reference time elapses after the cooling of the liquid reservoir 51 by the cooling device 54 is started in step S324, the control device 100 of the present embodiment determines in step S328 that the regulation of the liquid amount of the working fluid collecting in the device heat exchanger 12 is finished.

The processing of step S328 may be processing for determining whether or not the regulation of the liquid amount of the working fluid collecting in the device heat exchanger 12 is finished regardless of an elapsed time from the time when the cooling of the liquid reservoir 51 by the cooling device 54 is started in step S324.

For example, the control device 100 may be configured to determine that the regulation of the liquid amount of the working fluid in the device heat exchanger 12 is finished when the battery temperature Tb of the battery pack BP is increased to a specified temperature after the cooling of the liquid reservoir 51 by the cooling device 54 is started in step S324.

Further, the control device 100 may be configured so as to monitor an actual liquid amount of the working fluid in the device heat exchanger 12 and to determine that the regulation of the liquid amount of the working fluid collecting in the device heat exchanger 12 is finished when the actual liquid amount becomes more than a specified reference amount.

In a case where it is determined in step S328 that the regulation of the liquid amount of the working fluid collecting in the device heat exchanger 12 is finished, in step S330, the control device 100 stops cooling the liquid reservoir 51 by the cooling device 54 and controls the branch passage opening/closing valve 55 to a closed state.

The device temperature regulator 1 of the present embodiment described above can produce the same operations and effects produced by the configuration common to the first embodiment as is the case with the first embodiment. In particular, the device temperature regulator 1 of the present embodiment is configured so as to cool the liquid reservoir 51 by the cooling device 54 to increase the liquid storage amount of the liquid working fluid in the liquid reservoir 51 when the condition that requires the battery pack BP to be warmed up is satisfied.

In this way, if the device temperature regulator 1 of the present embodiment is configured so as to increase the liquid storage amount of the liquid working fluid stored in the liquid reservoir 51 at the time of warming up the battery pack BP, the liquid amount of the working fluid in the device heat exchanger 12 can be decreased. In other words, the device temperature regulator 1 of the present embodiment can increase the occupancy rate of the gaseous working fluid inside the portion to exchange heat with the battery pack BP of the device heat exchanger 12 at the time of the warming-up mode as compared with at the time of the cooling mode by regulating the liquid storage amount of the working fluid in the liquid reservoir 51.

According to this, at the time of warming up the battery pack BP, the gaseous working fluid evaporated by the heater 20 can be condensed by the device proximity part 121 proximate to the battery pack BP, so that the heat of the working fluid can be radiated to the battery pack BP via the device heat exchanger 12. At the time of warming up the battery pack BP, the battery pack BP is proximate to the portion in the device heat exchanger 12 in which the gaseous working fluid collects, so that the temperature variation of the battery pack BP can be sufficiently limited.

In particular, at the time of warming up the battery pack BP, an area in which the gaseous working fluid evaporated by the heater 20 is in contact with the gaseous working fluid at the inside portion of the device proximity part 121, exchanging heat with the battery pack BP, is increased, thereby increasing a range in which the gaseous working fluid on the inside of the device proximity part 121 is condensed.

Thus, according to the device temperature regulator 1 of the present embodiment, at the time of warming up the battery pack BP, the battery pack BP can be heated in a wide range, which hence can sufficiently suppress the temperature variation of the battery pack BP.

Further, the device temperature regulator 1 of the present embodiment is configured so as to close the branch passage part 52 by the branch passage opening/closing valve 55 when the liquid storage amount of the liquid working fluid in the liquid reservoir 51 reaches a specified reference amount at the time of the warming-up mode.

According to this, the working fluid is limited from moving between the liquid reservoir 51 and the device fluid circuit 10 after the liquid working fluid is stored in the liquid reservoir 51, which hence can prevent the working fluid in the liquid reservoir 51 from unintentionally moving to the device fluid circuit 10.

The device temperature regulator 1 is preferable to be configured such that the branch passage part 52 can be opened or closed by the branch passage opening/closing valve 55, but the present disclosure is not limited to this. The device temperature regulator 1 may be configured so as not to be provided with the branch passage opening/closing valve 55.

Further, as described above, the cooling device 54 is preferable to be provided adjacently to the lower surface part of the liquid reservoir 51, but the present disclosure is not limited to this. The cooling device 54 may be provided, for example, in at least one portion of the side surface of the liquid reservoir 51 or the branch passage part 52.

### Fifth Embodiment

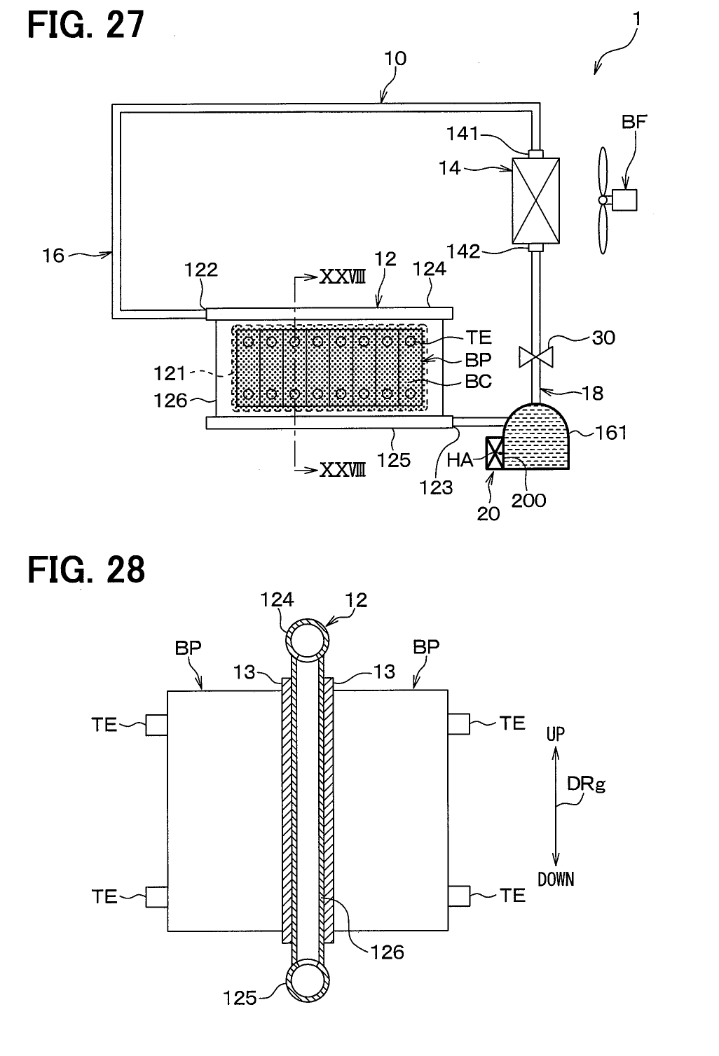

Next, a fifth embodiment will be described with reference to FIG. 27 to FIG. 32. The present embodiment is different from the first embodiment in that the device heat exchanger 12 is arranged at a position opposite to a side surface part of the battery pack BP. In the present embodiment, parts different from the first embodiment will be mainly described.

As shown in FIG. 27 and FIG. 28, the device heat exchanger 12 of the present embodiment is configured so as to include a cylindrical upper tank 124, a cylindrical lower tank 125, and a plurality of tubes 126 to make the upper tank 124 communicate with the lower tank 125. The device heat exchanger 12 may be configured so as to make the upper tank 124 communicate with the lower tank 125 by a hollow member having a plurality of flow passages formed therein in place of the plurality of tubes 126.

The respective members to configure the device heat exchanger 12 are configured of metal having an excellent thermal conductivity, for example, aluminum or copper. The respective members to configure the device heat exchanger 12 may be configured of a material having an excellent thermal conductivity other than the metal.

The upper tank 124 is provided on a portion on an upper side in the vertical direction DRg of the device heat exchanger 12. The upper tank 124 has a gas outlet part 122 provided on its one side in a longitudinal direction, the gas outlet part 122 having an end portion on a lower side of the gas passage part 16 connected thereto. The gas outlet part 122 configures a gas-side connection part to which the gas passage part 16 in the device heat exchanger 12 is connected.

The lower tank 125 is provided on a portion on the lower side in the vertical direction DRg of the device heat exchanger 12. The lower tank 125 has a liquid inlet part 123 provided on its one side in the longitudinal direction, the liquid inlet part 123 having an end portion on the lower side of the liquid passage part 18 connected thereto. The liquid inlet part 123 configures a liquid-side connection part to which the liquid passage part 18 in the device heat exchanger 12 is connected.

The battery pack BP is provided on the outside of the device heat exchanger 12 via a thermal conductive sheet 13 having an electric insulation. The device heat exchanger 12 has insulation from the battery pack BP secured and has a thermal resistance to the battery pack BP reduced by the thermal conductive sheet 13.

The device heat exchanger 12 is arranged so as to oppose to the battery pack BP in a direction orthogonal to the vertical direction DRg. In the device heat exchanger 12 of the present embodiment, a portion opposed to the battery pack BP in the direction orthogonal to the vertical direction DRg configures the device proximity part 12 to exchange heat with the battery pack BP. The device proximity part 121 is a heat transfer part to transfer heat between the battery pack BP and the device heat exchanger 12. In the present embodiment, the device proximity part 121 configures a heat exchange part to exchange heat with the battery pack BP in the device heat exchanger 12. The device proximity part 121 has a size large enough to cover the whole of the side surface part of the battery pack BP so as not to cause a temperature variation in the respective battery cells to configure the battery pack BP. The device proximity part 121 of the present embodiment extends along the vertical direction DRg.

The battery pack BP of the present embodiment is located such that a surface on a side opposite to a surface provided with a terminal TE is opposed to the device proximity part 121 of the device heat exchanger 12 via the thermal conductive sheet 13. The respective battery cells BC to configure the battery pack BP are arranged in a direction intersecting the vertical direction DRg.

In the device temperature regulator 1 of the present embodiment, the liquid passage part 18 is provided with the liquid passage opening/closing valve 30. The liquid passage opening/closing valve 30 functions as a liquid amount regulator that regulates the liquid amount of the liquid working fluid collecting in the device heat exchanger 12, as is the case with the first embodiment.

The liquid passage opening/closing valve 30 of the present embodiment is configured so as to regulate the liquid amount of the working fluid in the device heat exchanger 12 such that, at the time of warming up the battery pack BP, the occupancy rate of the gaseous working fluid inside the device proximity part 121 becomes larger as compared with at the time of cooling the battery pack BP.

Further, the liquid passage opening/closing valve 30 of the present embodiment is configured so as to regulate the liquid amount of the working fluid collecting in the device heat exchanger 12 such that, at the time of warming up the battery pack BP, the liquid working fluid collects in at least one portion of the heat receiving portion 200 to receive heat from the heater 20.

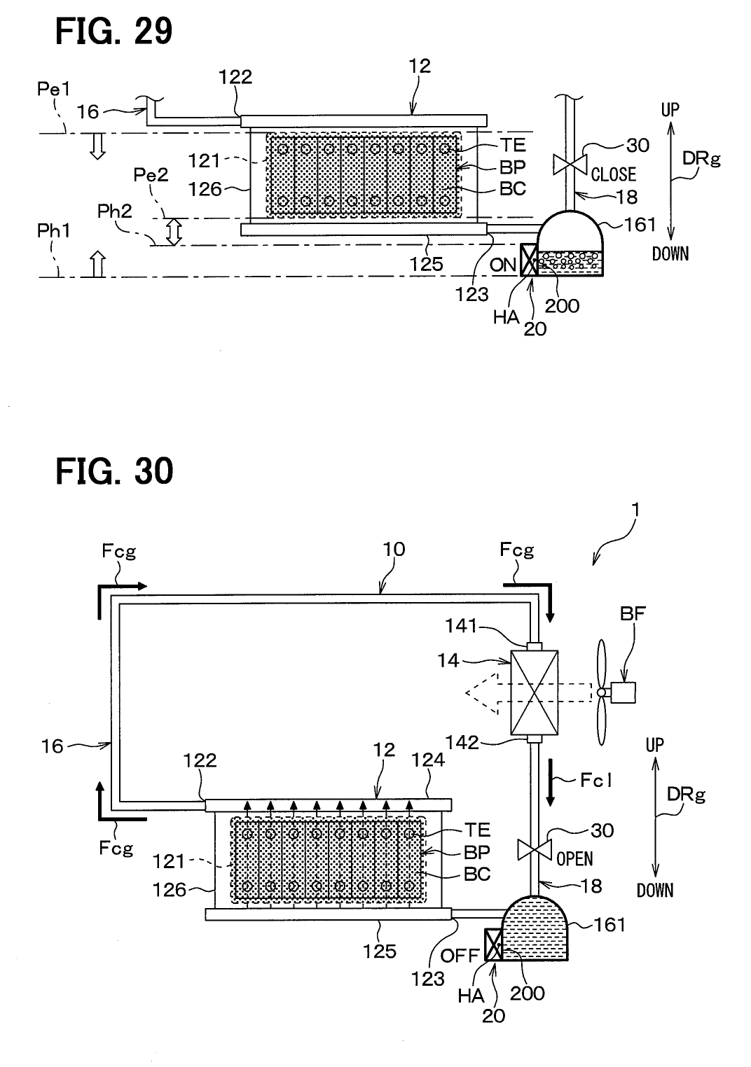

As shown in FIG. 29, the liquid passage opening/closing valve 30 of the present embodiment is configured so as to regulate the liquid amount of the working fluid collecting in the device heat exchanger 12 such that, at the time of warming up the battery pack BP, the liquid surface in the device heat exchanger 12 is located below an upper end position Pe1 of a heat exchange portion.

Here, it is preferable that the liquid passage opening/closing valve 30 is configured so as to regulate the liquid amount of the working fluid collecting in the device heat exchanger 12 such that, at the time of warming up the battery pack BP, the liquid surface in the device heat exchanger 12 is located below a lower end position Pe2 of the heat exchange portion. According to this, a range in which the working fluid on the inside of the device proximity part 121 is condensed can be most expanded.

Further, the liquid passage opening/closing valve 30 of the present embodiment is configured so as to regulate the liquid amount of the working fluid collecting in the device heat exchanger 12 such that, at the time of warming up the battery pack BP, the liquid surface in the device heat exchanger 12 is positioned above a lower end position Ph1 of a heat radiation portion HA of the heater 20.

Here, it is preferable that the liquid passage opening/closing valve 30 is configured so as to regulate the liquid amount of the working fluid collecting in the device heat exchanger 12 such that, at the time of warming up the battery pack BP, the liquid surface in the device heat exchanger 12 is located above an upper end position Ph2 of the heat radiation portion HA of the heater 20. According to this, an area in which heat is transferred to the liquid working fluid from the heater 20 can be sufficiently ensured.

Next, an operation of the device temperature regulator 1 of the present embodiment will be described with reference to FIG. 30 to FIG. 32. In the device temperature regulator 1 of the present embodiment, as shown in FIG. 30, at the time of the cooling mode, the liquid passage opening/closing valve 30 is brought into the open state and the blower fan BF is operated in a state where the heating of the working fluid by the heater 20 is stopped.

In this way, in the device heat exchanger 12, the liquid working fluid absorbs heat from the battery pack BP and a portion of the liquid working fluid is evaporated. The battery pack BP is cooled by the latent heat of evaporation of the working fluid collecting in the device heat exchanger 12 and hence has its temperature decreased.

The gaseous working fluid evaporated in the device heat exchanger 12 flows out to the gas passage part 16 from the gas outlet part 122 of the device heat exchanger 12 and moves to the condenser 14 via the gas passage part 16 as shown by an arrow Fcg in FIG. 30.

In the condenser 14, the gaseous working fluid radiates heat to air blown from the blower fan BF, thereby being condensed. In the condenser 14, the gaseous working fluid is liquefied and hence a specific gravity of the working fluid is increased. In this way, the working fluid liquefied in the condenser 14 goes down toward the liquid outlet part 142 of the condenser 14 by its own weight.

The liquid working fluid condensed in the condenser 14 flows out to the liquid passage part 18 from the liquid outlet part 142 of the condenser 14 and moves to the device heat exchanger 12 via the liquid passage part 18 as shown by an arrow Fcl in FIG. 30. Then, in the device heat exchanger 12, a portion of the liquid working fluid flowing into the device heat exchanger 12 from the liquid inlet part 123 via the liquid passage part 18 absorbs heat from the battery pack BP, thereby being evaporated.

In this way, in the device temperature regulator 1, at the time of the cooling mode, the working fluid is circulated between the device heat exchanger 12 and the condenser 14 while changing the phase between the gas phase and the liquid phase and hence the heat is transferred from the device heat exchanger 12 to the condenser 14, and thereby the battery pack BP is cooled.

Here, at the time of the cooling mode, the liquid passage opening/closing valve 30 is opened. For this reason, at the time of the cooling mode, the internal space of the device heat exchanger 12 is filled with the liquid working fluid containing the bubbles. In other words, at the time of the cooling mode, the liquid working fluid is brought into contact with the inside of the device proximity part 121 of the device heat exchanger 12. For this reason, at the time of the cooling mode, the battery pack BP can be sufficiently cooled by a heat absorption effect produced by the evaporation of the liquid working fluid collecting in the device heat exchanger 12.

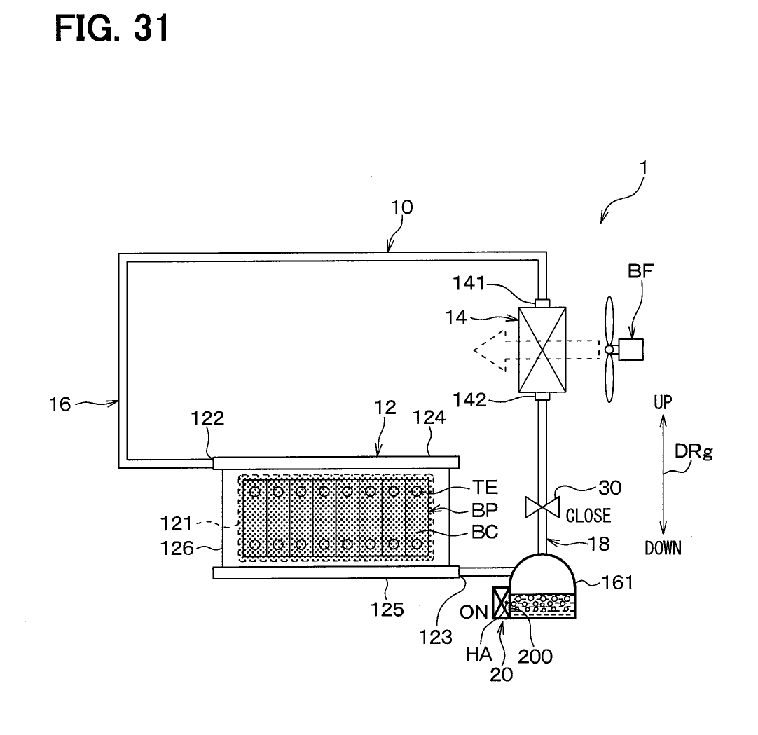

Further, in the device temperature regulator 1 of the present embodiment, as shown in FIG. 31, at the time of the warming-up mode, the blower fan BF is operated in a state where the liquid passage opening/closing valve 30 is closed and where the heating of the working fluid by the heater 20 is started.

When the heat radiation of the working fluid collecting in the condenser 14 is started by operating the blower fan BF, the liquid working fluid is stored in the condenser 14, and thereby the liquid surface of the working fluid in the device heat exchanger 12 goes down to a position below an upper end of the device proximity part 121.

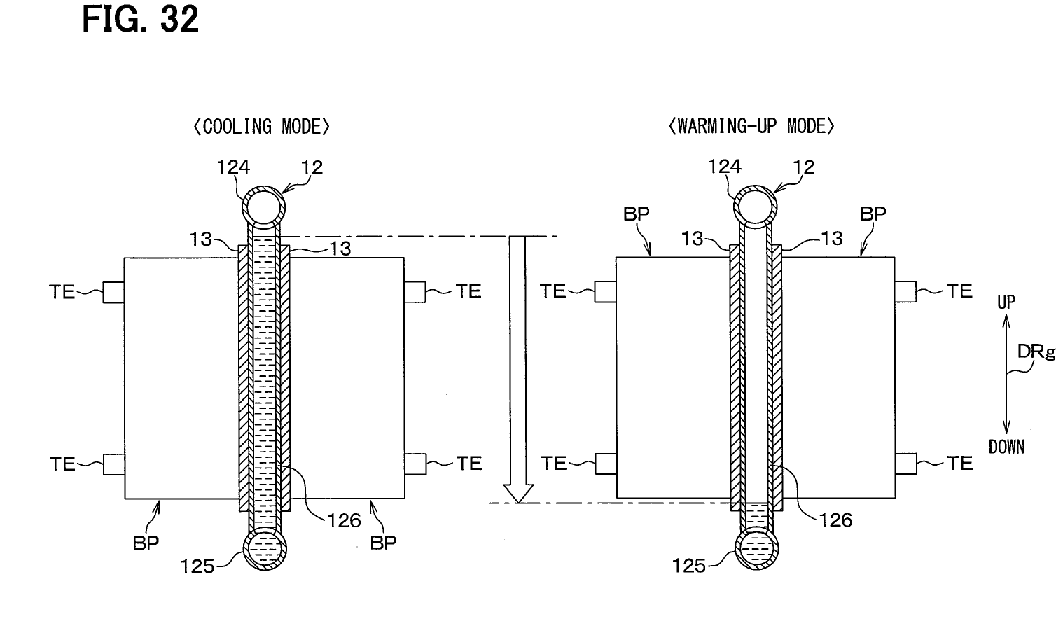

In this way, as shown in FIG. 32, in the device temperature regulator 1, at the time of the warming-up mode, the occupancy rate of the gaseous working fluid on the inside of the device proximity part 121 of the device heat exchanger 12 becomes larger as compared with at the time of the cooling mode.

In addition, in the device temperature regulator 1 of the present embodiment, even if the liquid passage opening/closing valve 30 is closed, the liquid working fluid collects in the heat receiving portion 200 to receive heat from the heater 20. For this reason, in the device temperature regulator 1, the working fluid heated and evaporated by the heater 20 is condensed near the device proximity part 121 of the device heat exchanger 12. In other words, in the device temperature regulator 1, at the time of the warming-up mode, the working fluid is condensed near the device proximity part 121 of the device heat exchanger 12 and the heat of the working fluid is radiated to the battery pack BP at the time, so that the battery pack BP is heated.

The other configuration is the same as the first embodiment. In the device temperature regulator 1 of the present embodiment, at the time of warming up the battery pack BP, the area in which the gaseous working fluid is in contact with the inside portion, exchanging heat with the battery pack BP in the device heat exchanger 12, becomes larger, so that the area in which the working fluid on the inside of the device proximity part 121 is condensed can be expanded. For this reason, also by the device temperature regulator 1 of the present embodiment, at the time of warming up the battery pack BP, the battery pack BP can be heated in a wide range, so that it is possible to suppress the temperature variation of the battery pack BP from being expanded at the time of the warming-up of the battery pack BP.

Here, in the present embodiment, the example in which the liquid amount regulator is configured of the liquid passage opening/closing valve 30 has been described, but the present disclosure is not limited to this. The liquid amount regulator may be configured of those shown in the second embodiment to the fourth embodiment.

### Sixth Embodiment

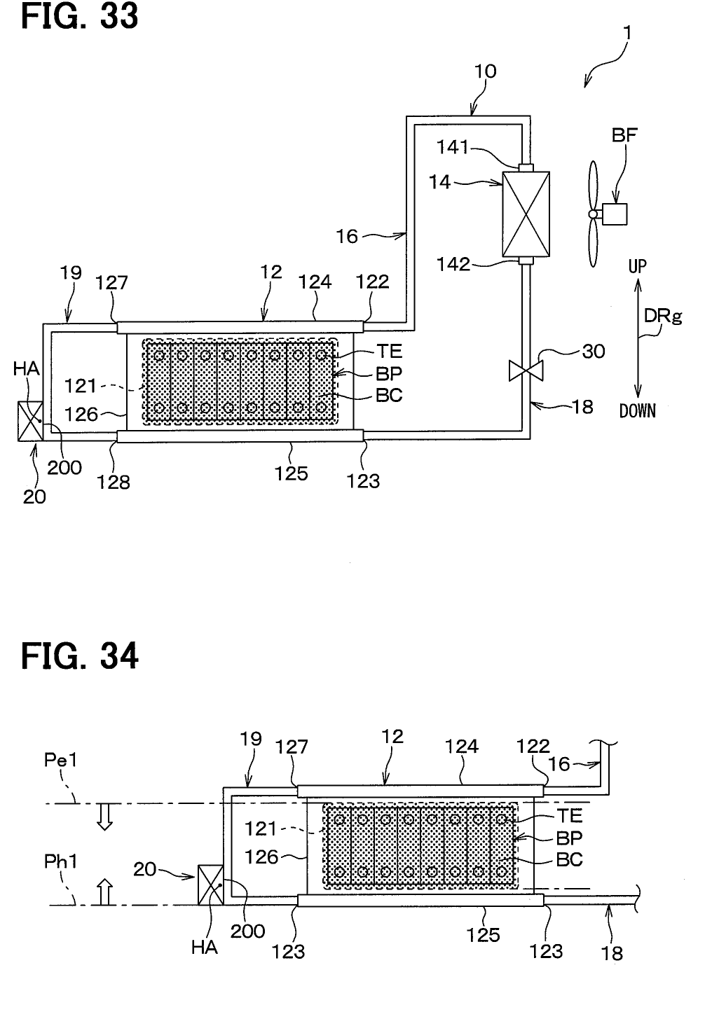

Next, a sixth embodiment will be described with reference to FIG. 33 to FIG. 36. The present embodiment is different from the fifth embodiment in that the device fluid circuit 10 is additionally provided with a bypass passage part 19. In the present embodiment, parts different from the fifth embodiment will be mainly described.

As shown in FIG. 33, the device fluid circuit 10 of the present embodiment is configured so as to include the bypass passage part 19 that causes the upper tank 124 and the lower tank 125 of the device heat exchanger 12 to communicate with each other without using the condenser 14.

The bypass passage part 19 has its one end side connected to an upper connection part 127 provided in the upper tank 124 and has its other end side connected to a lower connection part 128 provided in the lower tank 125. The bypass passage 19 may be configured so as to connect a middle portion of the gas passage part 16 to a middle portion of the liquid passage part 18.

The bypass passage part 19 is provided with the heater 20 that heats the working fluid collecting in the bypass passage part 19. The heater 20 is located such that the heat radiation portion HA is located below an upper end of the device proximity part 121 in the device heat exchanger 12.

The liquid passage opening/closing valve 30 of the present embodiment is configured so as to regulate the liquid amount of the working fluid in the device heat exchanger 12 such that, at the time of warming up the battery pack BP, the occupancy rate of the gaseous working fluid on the inside of the device proximity part 121 becomes larger as compared with at the time of cooling the battery pack BP.

Further, the liquid passage opening/closing valve 30 of the present embodiment is configured so as to regulate the liquid amount of the working fluid collecting in the device heat exchanger 12 such that, at the time of warming up the battery pack BP, the liquid working fluid collects in at least one portion of the heat receiving portion 200 to receive heat from the heater 20.

As shown in FIG. 34, the liquid passage opening/closing valve 30 of the present embodiment is configured so as to regulate the liquid amount of the working fluid collecting in the device heat exchanger 12 such that, at the time of warming up the battery pack BP, the liquid surface in the device heat exchanger 12 is located below the upper end position Pe1 of the heat exchange portion.

Further, the liquid passage opening/closing valve 30 of the present embodiment is configured so as to regulate the liquid amount of the working fluid collecting in the device heat exchanger 12 such that, at the time of warming up the battery pack BP, the liquid surface in the device heat exchanger 12 is located above the lower end position Ph1 of the heat radiation portion HA of the heater 20.

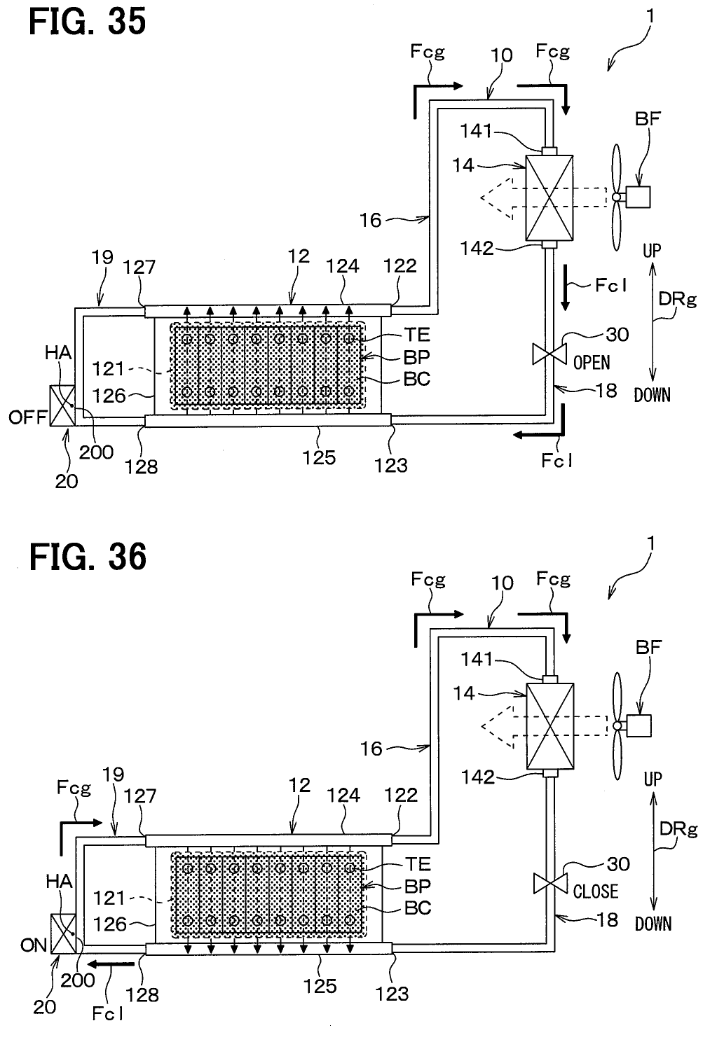

Next, an operation of the device temperature regulator 1 of the present embodiment will be described with reference to FIG. 35 and FIG. 36. In the device temperature regulator 1 of the present embodiment, as shown in FIG. 35, at the time of the cooling mode, the blower fan BF is operated in a state where the liquid passage opening/closing valve 30 is opened and where the heating of the working fluid by the heater 20 is stopped.

In this way, in the device heat exchanger 12, the liquid working fluid absorbs heat from the battery pack BP and a portion of the liquid working fluid is evaporated. The battery pack BP is cooled by the latent heat of evaporation of the working fluid collecting in the device heat exchanger 12 and hence has its temperature decreased.

The gaseous working fluid evaporated in the device heat exchanger 12 flows out to the gas passage part 16 from the gas outlet part 122 of the device heat exchanger 12 and moves to the condenser 14 via the gas passage part 16 as shown by an arrow Fcg in FIG. 35.

In the condenser 14, the gaseous working fluid radiates heat to air blown from the blower fan BF, thereby being condensed. In the condenser 14, the gaseous working fluid is liquefied and hence a specific gravity of the working fluid is increased. In this way, the working fluid liquefied in the condenser 14 goes down toward the liquid outlet part 142 of the condenser 14 by its own weight.

The liquid working fluid condensed in the condenser 14 flows out to the liquid passage part 18 from the liquid outlet part 142 of the condenser 14 and moves to the device heat exchanger 12 via the liquid passage part 18 as shown by an arrow Fcl in FIG. 35. Then, in the device heat exchanger 12, a portion of the liquid working fluid flowing into the device heat exchanger 12 from the liquid inlet part 123 via the liquid passage part 18 absorbs heat from the battery pack BP, thereby being evaporated.

Here, a portion of the liquid working fluid condensed in the condenser 14 flows in the bypass passage part 19 but the heater 20 is stopped, so that the liquid working fluid is not evaporated in the bypass passage 19. For this reason, at the time of cooling mode, a flow of the working fluid is hardly caused in the bypass passage part 19.

In this way, in the device temperature regulator 1, at the time of the cooling mode, the working fluid is circulated between the device heat exchanger 12 and the condenser 14 while changing the phase between the gas phase and the liquid phase and the heat is transferred to the condenser 14 from the device heat exchanger 12, and thereby the battery pack BP is cooled.

At the time of cooling mode, the liquid passage opening/closing valve 30 is opened. For this reason, at the time of the cooling mode, the internal space of the device heat exchanger 12 is filled with the liquid working fluid containing the bubbles. In other words, at the time of the cooling mode, the liquid working fluid is brought into contact with the inside of the device proximity part 121 of the device heat exchanger 12. For this reason, at the time of the cooling mode, the battery pack BP can be sufficiently cooled by a heat absorption effect produced by the evaporation of the liquid working fluid collecting in the device heat exchanger 12.

Further, in the device temperature regulator 1 of the present embodiment, as shown in FIG. 36, at the time of the warming-up mode, the blower fan BF is operated in a state where the liquid passage opening/closing valve 30 is closed and where the heating of the working fluid by the heater 20 is started.

When the blower fan BF is operated and the heat radiation of the working fluid collecting in the condenser 14 is started, the liquid working fluid is stored in the condenser 14, and thereby the liquid surface of the working fluid in the device heat exchanger 12 goes down to a position below an upper end of the device proximity part 121. In this way, in the device temperature regulator 1, at the time of the warming-up mode, the occupancy rate of the gaseous working fluid on the inside of the device proximity part 121 of the device heat exchanger 12 becomes larger as compared with at the time of the cooling mode.

In this state, the working fluid collecting in the bypass passage part 19 is heated by the heater 20. Then, the working fluid heated and evaporated by the heater 20 flows into the device heat exchanger 12 from the upper connection part 127. Almost all of the gaseous working fluid flowing into the device heat exchanger 12, except for the gaseous working fluid flowing to the condenser 14 side, is condensed near the device proximity part 121 of the device heat exchanger 12. In short, in the device temperature regulator 1, at the time of the warming-up mode, the working fluid is condensed near the device proximity part 121 of the device heat exchanger 12 and the heat of the working fluid at that time is radiated to the battery pack BP, so that the battery pack is heated. Then, the working fluid condensed near the device proximity part 121 of the device heat exchanger 12 flows out to the bypass passage part 19 via the lower connection part 128 and is again heated by the heater 20.

The other configuration is the same as the first embodiment. In the device temperature regulator 1 of the present embodiment, at the time of warming up the battery pack BP, the area in which the gaseous working fluid is in contact with the inside portion to exchange heat with the battery pack BP in the device heat exchanger 12 becomes larger, so that the area in which the working fluid on the inside of the device proximity part 121 is condensed can be expanded. For this reason, also by the device temperature regulator 1 of the present embodiment, at the time of warming up the battery pack BP, the battery pack BP can be heated in a wide range, so that it is possible to suppress the temperature variation of the battery pack BP from being expanded at the time of the warming-up of the battery pack BP.

In the present embodiment, the example in which the liquid amount regulator is configured of the liquid passage opening/closing valve 30 has been described, but the present disclosure is not limited to this. The liquid amount regulator may be configured of those shown in the second embodiment to the fourth embodiment.

Further, in the present embodiment, an example in which at the time of warming up the battery pack BP, the heat radiation amount in the condenser 14 is increased by operating the blower fan BF has been described, but the present invention is not limited to this. In a case where the temperature around the condenser 14 is low, even if the blower fan BF is not operated, the working fluid is condensed in the condenser 14 in some cases. For this reason, the device temperature regulator 1 may be configured so as not to increase the heat radiation amount in the condenser 14 at the time of warming up the battery pack BP. This is the same also in the first embodiment and the like.

### Other Embodiments

Up to this point, typical embodiments of the present disclosure have been described, and the present disclosure is not limited to the embodiments described above but, for example, can be variously modified as will be described below.

In the first embodiment, the example in which the liquid passage opening/closing valve 30 is configured of the electromagnetic valve has been described, but the liquid passage opening/closing valve 30 may be configured of, for example, a mechanical valve having a valve mechanism operated without being energized. This is the same also in the gas passage opening/closing valve 32 of the second embodiment and in the branch passage opening/closing valve 55 of the fourth embodiment.

In the respective embodiments described above, the examples in which the gas outlet part 122 and the liquid inlet part 123 of the device heat exchanger 12 are provided on the side surface portions opposed to each other have been described, but the present disclosure is not limited to this. The gas outlet part 122 and the liquid inlet part 123 may be provided, for example, on an upper surface part of the device heat exchanger 12.

Further, the gas outlet part 122 and the liquid inlet part 123 of the device heat exchanger 12 may be different from each other in a height in the vertical direction DRg. In this case, it is preferred that the gas outlet part 122 is provided at a position higher than the liquid inlet part 123.

As described in the respective embodiments, it is preferable that the liquid amount of the working fluid of the device heat exchanger 12 is regulated by the liquid amount regulator such that, at the time of warming up the battery pack BP, the liquid surface of the working fluid in the device heat exchanger 12 is located between the device proximity part 121 and the heat radiation portion HA of the heater 20, but the present disclosure is not limited to this. The liquid amount regulator may be configured so as to regulate the liquid amount of the working fluid in the device heat exchanger 12 such that, at the time of warming up the battery pack BP, the liquid surface of the working fluid in the device heat exchanger 12 is located at least on the lower side of the device proximity part 121.

In the respective embodiments described above, the examples in which the temperature of the single battery pack BP is regulated by the device temperature regulator 1 have been described, but the present disclosure is not limited to this. The device temperature regulator 1 can regulate the temperatures of a plurality of devices.

In the respective embodiments, the condition satisfied when the battery temperature Tb of the battery pack BP is lower than the previously set allowable lower limit temperature Tbmin of the battery pack BP is employed as the condition in which the battery pack BP needs to be warmed up, but the present disclosure is not limited to this. The condition in which the battery pack BP needs to be warmed up may be, for example, a condition satisfied when an ambient temperature around the battery pack BP becomes a specified temperature or less.

In the respective embodiments described above, the examples in which the device temperature regulator 1 of the present disclosure is applied to a device for regulating the battery temperature Tb of the battery pack BP mounted on the vehicle have been described, but the present disclosure is not limited to this. In other words, the device temperature regulator 1 of the present disclosure can be widely applied not only to the battery pack BP but also to a device for regulating a temperature of the other instrument.

In the embodiments described above, needless to say, elements configuring the embodiments are not necessarily essential except where the elements are specified to be especially essential and except where the elements are clearly essential in principle.

In the embodiments described above, in a case where numerical values such as a number, a numerical value, an amount, and a range of the constituent element of the embodiment are referred to, except where the numerical values are specified to be especially essential or except where the numerical values are clearly limited to the specified numbers in principle, the numerical values are not limited to the specified numerical values.

In the embodiments described above, when a shape and a position relation of the constituent element or the like are referred to, except where the shape and the position relation are specified to be especially essential or except where the shape and the position relation are limited to a specified shape and a specified position relation in principle, the shape and the position relation are not limited to the specified shape and the specified position relation.

According to a first aspect shown in a part or all of the embodiments described above, the device temperature regulator is provided with at least one heater for heating the working fluid collecting in the device fluid circuit 10 and the liquid amount regulator for regulating the liquid amount of the working fluid collecting in the device heat exchanger.

Accordingly, at the time of warming up the temperature regulation target device, the liquid amount of the working fluid in the device heat exchanger can be regulated by the liquid amount regulator for example, so as to suppress a liquid working fluid from collecting in a heat exchanging part exchanging heat with a temperature regulation target space in the device heat exchanger. For this reason, in the device temperature regulator of the present disclosure, by regulating the liquid amount of the working fluid in the device heat exchanger at the time of warming up the temperature regulation target device, a temperature variation in the temperature regulation target device can be limited from being expanded at the time of warming up the temperature regulation target device.

According to a second aspect, in the device temperature regulator, at least a part of the heat receiving portion configured to receive heat from the heater in the device fluid circuit is located below an upper end of the heat exchange portion. Then, the liquid amount regulator is configured to regulate the liquid amount of the working fluid collecting in the device heat exchanger such that, when the condition in which the temperature regulation target device needs to be warmed up is satisfied, the liquid working fluid collects at least in the part of the heat receiving portion.

According to this, at the time of warming up the temperature regulation target device, the liquid working fluid collecting in the heat receiving portion can be evaporated by the heater and the evaporated gaseous working fluid can be condensed by the heat exchange portion. In other words, according to this configuration, the heat of the working fluid can be easily radiated to the temperature regulation target device via the device heat exchanger. For this reason, the temperature regulation target device can be efficiently warmed up.

According to a third aspect, the heater includes a heat radiation portion configured to radiate the heat to the working fluid and is arranged on the lower side of at least one of the gas-side connection part or the liquid-side connection part in the vertical direction. Here, the gas-side connection part of the device heat exchanger is connected to the gas passage part, and the liquid-side connection part of the device heat exchanger is connected to the liquid passage part.

According to this, the liquid working fluid collecting in the device heat exchanger can easily flow to the heater side and the gaseous working fluid, which is heated and evaporated by the heater, can easily flow to the device heat exchanger side. For this reason, in the device temperature regulator of the present disclosure, the heat of the working fluid can be radiated to the temperature regulation target device via the device heat exchanger.

According to a fourth aspect, the liquid amount regulator of the device temperature regulator can regulate the liquid amount of the working fluid in the device heat exchanger such that, at the time of warming up the temperature regulation target device, the liquid surface of the working fluid in the device heat exchanger is located above at least one of the respective connection parts.

According to this, at the time of warming up the temperature regulation target device, the liquid working fluid collecting in the device heat exchanger can easily flow to the side of the heater via at least one of the gas-side connection part and the liquid-side connection part, so that the liquid working fluid can be evaporated suitably by the heating of the heater.

According to a fifth aspect, the device temperature regulator is provided with the liquid passage opening/closing valve that opens or closes the liquid passage part to regulate the supply amount of the liquid working fluid to the device heat exchanger. Then, the liquid passage opening/closing valve is configured so as to close the liquid passage part such that when the condition that requires the temperature regulation target device to be warmed up is satisfied, the supply of the liquid working fluid to the device heat exchanger is stopped.

In this configuration, the supply of the liquid working fluid to the device heat exchanger is stopped and the liquid working fluid is stored on the upper side of the liquid passage opening/closing valve, so that the liquid amount of the working fluid in the device heat exchanger can be reduced. In this way, at the time of warming up the temperature regulation target device, the gaseous working fluid evaporated by the heater can be condensed at the heat exchange portion to exchange heat with the temperature regulation target device, so that the heat of the working fluid can be radiated to the temperature regulation target device via the device heat exchanger.

According to a sixth aspect, the liquid amount regulator of the device temperature regulator is configured to include the heat radiation amount regulator that regulates the heat radiation amount of the working fluid in the condenser. The heat radiation amount regulator is configured to increase the heat radiation amount of the working fluid in the condenser when the condition that requires the temperature regulation target device to be warmed up is satisfied. According to this, at the time of warming up the temperature regulation target device, the liquid storage amount of the working fluid in the condenser is increased, and thereby the liquid amount of the working fluid in the device heat exchanger can be quickly reduced.

According to a seventh aspect, the heat radiation amount regulator of the device temperature regulator is configured to reduce the heat radiation amount of the working fluid in the condenser when the condition in which the liquid amount of the working fluid in the device heat exchanger becomes lower than the specified reference liquid amount is satisfied at the time of warming up the temperature regulation target device.

According to this, when the supply of the liquid working fluid to the device heat exchanger is stopped and then the liquid amount of the working fluid in the device heat exchanger becomes lower than the specified reference liquid amount, the heat radiation amount in the condenser is reduced. In this way, the gaseous working fluid, which is heated and evaporated by the heater, is restricted from flowing into a side of the condenser, so that the liquid amount of the working fluid in the device heat exchanger can be held at a suitable amount.

According to an eighth aspect, the device temperature regulator is configured so as to include the gas passage opening/closing valve which opens or closes the gas passage part. The gas passage opening/closing valve is configured so as to close the gas passage part such that when the condition in which the liquid amount of the working fluid in the device heat exchanger becomes lower than the specified reference liquid amount is satisfied at the time of warming up the temperature regulation target device, the supply of the gaseous working fluid to the condenser is stopped.

According to this, when the liquid amount of the working fluid in the device heat exchanger becomes lower than the specified reference liquid amount at the time of warming up the temperature regulation target device, the gaseous working fluid which is heated and evaporated by the heater is limited from flowing into the side of the condenser. In this way, the liquid amount of the working fluid in the device heat exchanger at the time of warming up the temperature regulation target device can be held at a suitable amount.

Further, after the gas passage part 16 is closed by the gas passage opening/closing valve 32, almost all of the heat amount from the heater 20 is used for warming up the temperature regulation target device, so that an energy efficiency at the time of warming up the temperature regulation target device is improved.

According to a ninth aspect, the liquid amount regulator of the device temperature regulator is configured to include the volume regulation part for regulating an internal volume of the device fluid circuit. Then, the volume regulation part is configured so as to increase the internal volume of the device fluid circuit when the condition that requires the temperature regulation target device to be warmed up is satisfied.

In this way, if the volume regulation part is configured to increase the internal volume of the device fluid circuit at the time of warming up the temperature regulation target device, the liquid working fluid is stored in a space increased by the volume regulation part and hence the liquid amount of the working fluid in the device heat exchanger can be reduced.

According to this, at the time of warming up the temperature regulation target device, the gaseous working fluid evaporated by the heater can be condensed by the heat exchange portion to exchange heat with the temperature regulation target device, so that the heat of the working fluid can be radiated to the temperature regulation target device via the device heat exchanger.

Further, according to a tenth aspect, the volume regulation part of the device temperature regulator is configured to include the liquid reservoir of the variable volume type in which the internal volume can be varied. Then, the liquid reservoir is provided on the lower side of the heat exchange portion to exchange heat with the temperature regulation target device in the device heat exchanger in the vertical direction.

According to this, the liquid working fluid collecting in the device heat exchanger can easily flow to the liquid reservoir by its own weight, so that the liquid amount of the working fluid in the device heat exchanger can be suitably reduced at the time of the warming up of the temperature regulation target device.

Further, according to an eleventh aspect, the liquid reservoir of the device temperature regulator is provided at the lower side of at least one of the gas-side connection part connected to the gas passage part or the liquid-side connection part connected to the liquid-side connection part in the vertical direction, in the device heat exchanger.

According to this, the liquid working fluid collecting in the device heat exchanger can easily flow into the liquid reservoir, so that the liquid working fluid can be moved to the tank part from the device heat exchanger at the time of warming up the temperature regulation target device.

According to a twelfth aspect, the heater of the device temperature regulator includes the heat radiation part configured to radiate the heat to the working fluid, and the heat radiation part is arranged on the lower side of the liquid reservoir in the vertical direction. According to this, the gaseous working fluid heated and evaporated by the heater can easily flow to the device heat exchanger from the liquid reservoir, so that the heat of the working fluid can be transferred to the temperature regulation target device via the device heat exchanger.

According to a thirteenth aspect, the liquid amount regulator of the device temperature regulator is configured to include the liquid reservoir and the cooling device which are provided so as to be branched in the device fluid circuit. The liquid reservoir stores the working fluid collecting in the device fluid circuit. The cooling device is configured to cool the working fluid collecting in the liquid reservoir by the cooling device to thereby increase the liquid storage amount of the liquid working fluid in the liquid reservoir when the condition that requires the temperature regulation target device to be warmed up is satisfied.

In this way, if the device temperature regulator is configured so as to cool the liquid reservoir by the cooling device to thereby increase the liquid storage amount of the liquid working fluid in the liquid reservoir at the time of warming up the temperature regulation target device, the liquid working fluid collecting in the device fluid circuit can be reduced.

According to this, at the time of warming up the temperature regulation target device, the gaseous working fluid evaporated by the heater can be condensed at the heat exchange portion to exchange heat with the temperature regulation target device, so that the heat of the working fluid can be radiated to the temperature regulation target device via the device heat exchanger.

According to a fourteenth aspect, the liquid amount regulator of the device temperature regulator is configured so as to include the liquid shutter which shuts the movement of the working fluid between the liquid reservoir and the device fluid circuit. Then, the liquid shutter is configured so as to shut the movement of the working fluid between the liquid reservoir and the device fluid circuit after the condition that requires the temperature regulation target device to be warmed up is satisfied.

According to this, after the liquid working fluid is stored in the liquid reservoir, the movement of the working fluid between the liquid reservoir and the device fluid circuit is shut, so that it is possible to prevent the working fluid in the liquid reservoir from flowing into the device fluid circuit after the liquid working fluid is stored in the liquid reservoir.

According to a fifteenth aspect, in the device temperature regulator, the temperature regulation target device is configured of the battery pack mounted on the vehicle. According to this, it is possible to suppress the temperature of the battery pack from being excessively lowered and hence to avoid the input characteristics from being impaired by an increase in the internal resistance which is caused by a suppression of a chemical change in the battery pack.

According to a sixteenth aspect, in the device temperature regulator, the working fluid has a characteristic in which the density ratio of the saturated liquid density to the saturated gas density becomes larger as the saturated temperature becomes lower. In a case where the working fluid having such a characteristic is used, the liquid amount in the device fluid circuit becomes smaller under an environmental condition in which the temperature of the temperature regulation target device is decreased. For this reason, at the time of warming up the temperature regulation target device, the volume necessary for storing the liquid working fluid in the device fluid circuit can be reduced. In other words, in a case where the working fluid having the characteristic such that the density ratio of the saturated liquid density to the saturated gas density becomes larger as the saturated temperature becomes lower is used as the working fluid, the device temperature regulator can be reduced in size.

What is claimed is:

1. A device temperature regulator capable of regulating a temperature of at least one temperature regulation target device, the device temperature regulator comprising:
a device heat exchanger configured to function as an evaporator in which a liquid working fluid is evaporated by absorbing heat from the temperature regulation target device at the time of cooling the temperature regulation target device, and to function as a heat radiator in which a gaseous working fluid is condensed to radiate heat to the temperature regulation target device at the time of warming up the temperature regulation target device;
a condenser that is disposed above the device heat exchanger to condense a gaseous working fluid evaporated in the device heat exchanger at the time of cooling the temperature regulation target device;
a gas passage part configured to guide the gaseous working fluid evaporated in the device heat exchanger to the condenser;
a liquid passage part configured to guide the liquid working fluid condensed in the condenser to the device heat exchanger;
at least one heater configured to heat the working fluid in a device fluid circuit that is configured to include the device heat exchanger, the condenser, the gas passage part, and the liquid passage part; and
a liquid amount regulator configured to regulate a liquid amount of the working fluid collecting in the device heat exchanger, wherein
the device heat exchanger is configured to include a heat exchange portion disposed opposite to the temperature regulation target device to exchange heat with the temperature regulation target device, and
the liquid amount regulator is configured to regulate the liquid amount of the liquid working fluid collecting in the device heat exchanger such that an occupancy rate of the gaseous working fluid inside the heat exchange portion becomes larger at the time of warming up the temperature regulation target device as compared with that at the time of cooling the temperature regulation target device.

2. The device temperature regulator according to claim 1, wherein
at least a part of a heat receiving portion configured to receive heat from the heater in the device fluid circuit is located below an upper end of the heat exchange portion, and
the liquid amount regulator is configured to regulate the liquid amount of the working fluid collecting in the device heat exchanger such that when a warming-up condition that requires the temperature regulation target device to be warmed up is satisfied, the liquid working fluid collects in at least the part of the heat receiving portion.

3. The device temperature regulator according to claim 1, wherein
the heater includes a heat radiating portion that is configured to radiate heat to the working fluid and is located on a lower side of at least one of a gas-side connection part or a liquid-side connection part of the device heat exchanger in a vertical direction, wherein the gas-side connection part of the device heat exchanger is connected to the gas passage part, and the liquid-side connection part of the device heat exchanger is connected to the liquid passage part.

4. The device temperature regulator according to claim 3, wherein
the liquid amount regulator is configured to regulate the liquid amount of the working fluid collecting in the device heat exchanger such that when the warming-up condition that requires the temperature regulation target device to be warmed up is satisfied, a liquid surface of the liquid working fluid in the device heat exchanger is positioned above at least one of the gas-side connection part or the liquid-side connection part in the vertical direction.

5. The device temperature regulator according to claim 1, wherein
the liquid amount regulator is configured to include a liquid passage opening/closing valve that opens or closes the liquid passage part to regulate a supply amount of the liquid working fluid supplied to the device heat exchanger, and
the liquid passage opening/closing valve is configured to close the liquid passage part such that when the warming-up condition that requires the temperature regulation target device to be warmed up is satisfied, the supply of the liquid working fluid to the device heat exchanger is stopped.

6. The device temperature regulator according to claim 5, wherein
the liquid amount regulator is configured to include a heat radiation amount regulator that regulates a heat radiation amount of the working fluid in the condenser, and
the heat radiation amount regulator is configured to increase the heat radiation amount of the working fluid in the condenser when the warming-up condition that requires the temperature regulation target device to be warmed up is satisfied.

7. The device temperature regulator according to claim 6, wherein
the heat radiation amount regulator is configured to decrease the heat radiation amount of the working fluid in the condenser, when the warming-up condition that requires the temperature regulation target device to be warmed up is satisfied and when a condition in which the liquid amount of the working fluid in the device heat exchanger becomes lower than a specified reference liquid amount is satisfied.

8. The device temperature regulator according to claim 5, wherein
the liquid amount regulator includes a gas passage opening/closing valve that opens or closes the gas passage part, and
the gas passage opening/closing valve is configured to close the gas passage part such that when the warming-up condition that requires the temperature regulation target device to be warmed up is satisfied and when a condition in which the liquid amount of the liquid working fluid in the device heat exchanger becomes lower than a specified reference liquid amount, a supply of the gaseous working fluid to the condenser is stopped.

9. The device temperature regulator according to claim 1, wherein
the liquid amount regulator includes a volume regulation part configured to regulate an internal volume of the device fluid circuit, and
the volume regulation part is configured to increase the internal volume of the device fluid circuit such that when the warming-up condition that requires the temperature regulation target device to be warmed up is satisfied, the liquid amount of the working fluid collecting in the device heat exchanger is decreased.

10. The device temperature regulator according to claim 9, wherein
the volume regulation part is configured to include a liquid reservoir of a variable volume type having a variable internal volume, and
the liquid reservoir is located at a lower side of the heat exchange portion in the device heat exchanger in the vertical direction.

11. The device temperature regulator according to claim 10, wherein
the liquid reservoir is located at a lower side of at least one of a gas-side connection part connected to the gas passage part or a liquid-side connection part connected to the liquid passage part, in the device heat exchanger in the vertical direction.

12. The device temperature regulator according to claim 10, wherein the heater includes a heat radiation part configured to radiate heat to the working fluid, and the heat radiation part is located at a lower side of the liquid reservoir in the vertical direction.

13. The device temperature regulator according to claim 1, wherein
the liquid amount regulator is configured to include:
a liquid reservoir provided to be branched from the device fluid circuit and to store the working fluid collecting in the device fluid circuit; and
a cooling device configured to cool the liquid reservoir, and
the cooling device is configured to cool the working fluid in the liquid reservoir and to increase a liquid amount of the liquid working fluid stored in the liquid reservoir, when the warming-up condition that requires the temperature regulation target device to be warmed up is satisfied.

14. The device temperature regulator according to claim 13, wherein
the liquid amount regulator includes a fluid shutter configured to shut a movement of the working fluid between the liquid reservoir and the device fluid circuit, and
the fluid shutter is configured to shut the movement of the working fluid between the liquid reservoir and the device fluid circuit after the warming-up condition that requires the temperature regulation target device to be warmed up is satisfied.

15. The device temperature regulator according to claim 1, wherein the temperature regulation target device is configured of a battery pack mounted on a vehicle.

16. The device temperature regulator according to claim 1, wherein the working fluid has a characteristic in which a density ratio of a saturated liquid density to a saturated gas density becomes larger as a saturation temperature becomes lower.
